(19) United States
(12) Patent Application Publication
(10) Pub. No.: US 2019/0331914 A1
(43) Pub. Date: Oct. 31, 2019

(54) Experience Sharing with Region-Of-Interest Selection

(71) Applicant: Google LLC, Mountain View, CA (US)

(72) Inventors: Steven John Lee, San Francisco, CA (US); Indika Charles Mendis, Mountain View, CA (US); Max Benjamin Braun, San Francisco, CA (US); Bradley James Rhodes, Alameda, CA (US); Casey Ho, San Jose, CA (US); Michael Patrick Johnson, Sunnyvale, CA (US)

(21) Appl. No.: 15/885,506

(22) Filed: Jan. 31, 2018

Related U.S. Application Data
(63) Continuation of application No. 14/923,232, filed on Oct. 26, 2015, now abandoned.
Application No. 14/923,232 is a continuation of application No. 13/402,745, filed on Feb. 22, 2012, now abandoned.
(60) Provisional application No. 61/510,020, filed on Jul. 20, 2011.

(51) Int. Cl. G02B 27/01; G06F 3/16; G06F 3/00; G06F 3/01

(52) U.S. Cl. CPC G02B 27/017; G06F 3/167; G06F 3/165; G06F 3/005; G02B 2027/0178; G02B 2027/0138; G02B 2027/0141; G02B 2027/014; G06F 3/013

(57) ABSTRACT

An experience sharing session can be established with a wearable computing device. A field of view of an environment can be provided through a head-mounted display (HMD) of the wearable computing device. The HMD is operable to display a computer-generated image overlaying at least a portion of the view. At least one image of the environment can be captured using a camera associated with the wearable computing device. The wearable computing device can receive an indication of a region of interest within the environment via the experience sharing session. The wearable computing device can display, on the HMD, the indication of the region of interest.

### CROSS REFERENCE TO RELATED APPLICATIONS

This application is a continuation of U.S. patent application Ser. No. 14/923,232, filed Oct. 26, 2017, which is a continuation of U.S. patent application Ser. No. 13/402,745, filed Feb. 22, 2012, which claims priority to U.S. Patent App. No. 61/510,020, filed Jul. 20, 2011, the contents of all of which are incorporated by reference herein for all purposes.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology may be referred to as “near-eye displays.”

Near-eye displays are fundamental components of wearable displays, also sometimes called “head-mounted displays” (HMDs). A head-mounted display places a graphic display or displays close to one or both eyes of a wearer. To generate the images on a display, a computer processing system may be used. Such displays may occupy a wearer's entire field of view, or only occupy part of wearer's field of view. Further, head-mounted displays may be as small as a pair of glasses or as large as a helmet.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming.

### SUMMARY

In one aspect, a computer-implemented method is provided. A field of view of an environment is provided through a head-mounted display (HMD) of a wearable computing device. The HMD is operable to display a computer-generated image overlaying at least a portion of the view. The wearable computing device can be engaged in an experience sharing session. At least one image of the environment is captured using a camera associated with the wearable computing device. The wearable computing device determines a first portion of the at least one image that corresponds to a region of interest within the field of view. The wearable computing device formats the at least one image such that a second portion of the at least one image is of a lower-bandwidth format than the first portion. The second portion of the at least one image is outside of the portion that corresponds to the region of interest. The wearable computing device transmits the formatted at least one image as part of the experience-sharing session.

In another aspect, a method is provided. A field of view of an environment is provided through a head-mounted display (HMD) of a wearable computing device. The HMD is operable to display a computer-generated image overlaying at least a portion of the view. The wearable computing device can be engaged in an experience sharing session. An instruction of audio of interest is received at the wearable computing device. Audio input is received at the wearable computing device via one or more microphones. The wearable computing device determines whether the audio input includes at least part of the audio of interest. In response to determining that the audio input includes the at least part of the audio of interest, the wearable computing device generates an indication of a region of interest associated with the at least part of the audio of interest. The wearable computing device displays the indication of the region of interest as part of the computer-generated image.

In yet another aspect, a method is provided. An experience sharing session is established at a server. The server receives one or more images of a field of view of an environment via the experience sharing session. The server receives an indication of a region of interest within the field of view of the environment via the experience sharing session. A first portion of one or more images is determined that corresponds to the region of interest. The one or more images are formatted such that a second portion of the one or more images is formatted in a lower-bandwidth format that the first portion. The second portion of the one or more images is outside of the portion that corresponds to the region of interest. The formatted one or more images are transmitted.

In a further aspect, a wearable computing device is provided. The wearable computing device includes a processor and memory. The memory has one or more instructions that, in response to execution by the processor, cause the wearable computing device to perform functions. The functions include: (a) establish an experience sharing session, (b) receive one or more images of a field of view of an environment via the experience sharing session, (c) receive an indication of a region of interest within the field of view of the one or more images via the experience sharing session, (d) determine a first portion of the one or more images that corresponds to the region of interest, (e) format the one or more images such that a second portion of the one or more images is formatted in a lower-bandwidth format that the first portion, where the second portion of the one or more images is outside of the portion that corresponds to the region of interest, and (f) transmit the formatted one or more images.

In yet another aspect, an apparatus is provided. The apparatus includes: (a) means for establishing an experience sharing session, (b) means for receiving one or more images of a field of view of an environment via the experience sharing session, (c) means for receiving an indication of a region of interest within the field of view of the one or more images via the experience sharing session, (d) means for determining a first portion of the one or more images that corresponds to the region of interest, (e) means for formatting the one or more images such that a second portion of the one or more images is formatted in a lower-bandwidth format that the first portion, where the second portion of the one or more images is outside of the portion that corresponds to the region of interest, and (f) means for transmitting the formatted one or more images.

### BRIEF DESCRIPTION OF THE FIGURES

In the figures:

FIG. 1 is a simplified diagram of a sharing device, according to an exemplary embodiment.

FIG. 2A illustrates an example of a wearable computing device.

FIG. 2B illustrates an alternate view of the system illustrated in FIG. 2A.

FIG. 2C illustrates an example system for receiving, transmitting, and displaying data.

FIG. 2D illustrates an example system for receiving, transmitting, and displaying data.

FIG. 2E is a flow chart illustrating a cloud-based method, according to an exemplary embodiment.

FIG. 3A depicts use of a wearable computing device gazing at an environment in a gaze direction within a field of view

FIG. 3B depicts an example composite image of a region of interest and an environmental image.

FIG. 3C depicts additional example displays of a region of interest within an environment.

FIG. 4A illustrates a scenario where a single wearable computing device carries out various instructions involving images and regions of interest.

FIG. 4B continues illustrating the scenario where the single wearable computing device carries out various instructions involving images and regions of interest.

FIG. 4C illustrates a scenario where one wearable computing device carries out various instructions involving images and regions of interest as instructed by another wearable computing device.

FIG. 5A shows a scenario for snapping-to objects within a region of interest, in accordance with an example embodiment.

FIG. 5B shows a scenario for snapping-to arbitrary points and/or faces within a region of interest, in accordance with an example embodiment.

FIG. 5C shows a scenario for progressive refinement of captured images, in accordance with an example embodiment.

FIGS. 6A and 6B are example schematic diagrams of a human eye, in accordance with an example embodiment.

FIG. 6C shows examples of a human eye looking in various directions, in accordance with an example embodiment.

FIG. 7A shows example eye gaze vectors for pupil positions in the eye X axis/eye Y axis plane, in accordance with an example embodiment.

FIG. 7B shows example eye gaze vectors for pupil positions in the eye Y axis/Z axis plane, in accordance with an example embodiment.

FIG. 7C shows example eye gaze vectors for pupil positions in the eye X axis/Z axis plane, in accordance with an example embodiment.

FIG. 7D shows an example scenario for determining gaze direction, in accordance with an example embodiment.

FIGS. 8A and 8B depict a scenario where sounds determine regions of interest and corresponding indicators, in accordance with an example embodiment.

FIG. 9 is a flowchart of a method, in accordance with an example embodiment.

FIG. 10 is a flowchart of a method, in accordance with an example embodiment.

FIG. 11 is a flowchart of a method, in accordance with an example embodiment.

### DETAILED DESCRIPTION

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed systems and methods can be arranged and combined in a wide variety of different configurations, all of which are contemplated herein.

In the following detailed description, reference is made to the accompanying figures, which form a part thereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

### General Overview of Experience Sharing

Experience sharing generally involves a user sharing media that captures their experience with one or more other users. In an exemplary embodiment, a user may use a wearable computing device or another computing device to capture media that conveys the world as they are experiencing it, and then transmit this media to others in order to share their experience. For example, in an experience-sharing session (ESS), a user may share a point-of-view video feed captured by a video camera on a head-mounted display of their wearable computer, along with a real-time audio feed from a microphone of their wearable computer. Many other examples are possible as well.

In an experience-sharing session, the computing device that is sharing a user's experience may be referred to as a “sharing device” or a “sharer,” while the computing device or devices that are receiving real-time media from the sharer may each be referred to as a “viewing device” or a “viewer.” Additionally, the content that is shared by the sharing device during an experience-sharing session may be referred to as a “share.” Further, a computing system that supports an experience-sharing session between a sharer and one or more viewers may be referred to as a “server”, an “ES server,” “server system,” or “supporting server system.”

In some exemplary methods, the sharer may transmit a share in real time to the viewer, allowing the experience to be portrayed as it occurs. In this case, the sharer may also receive and present comments from the viewers. For example, a sharer may share the experience of navigating a hedge maze while receiving help or criticism from viewers. In another embodiment, the server may store a share so that new or original viewers may access the share outside of real time.

A share may include a single type of media content (i.e., a single modality of media), or may include multiple types of media content (i.e., multiple modalities of media). In either case, a share may include a video feed, a three-dimensional (3D) video feed (e.g., video created by two cameras that is combined to create 3D video), an audio feed, a text-based feed, an application-generated feed, and/or other types of media content.

Further, in some embodiments a share may include multiple instances of the same type of media content. For example, in some embodiments, a share may include two or more video feeds. For instance, a share could include a first video feed from a forward-facing camera on a head-mounted display (HMD), and a second video feed from a camera on the HMD that is facing inward towards the wearer's face. As another example, a share could include multiple audio feeds for stereo audio or spatially-localized audio providing surround sound.

In some implementations, a server may allow a viewer to participate in a voice chat that is associated with the experience-sharing session in which they are a viewer. For example, a server may support a voice chat feature that allows viewers and/or the sharer in an experience-sharing session to enter an associated voice-chat session. The viewers and/or the sharer who participate in a voice-chat session may be provided with a real-time audio connection with one another, so that each of those devices can play out the audio from all the other devices in the session. In an exemplary embodiment, the serving system supporting the voice-chat session may sum or mix the audio feeds from all participating viewers and/or the sharer into a combined audio feed that is output to all the participating devices. Further, in such an embodiment, signal processing may be used to minimize noise when audio is not received from a participating device (e.g., when the user of that device is not speaking). Further, when a participant exits the chat room, that participant's audio connection may be disabled. (Note however, that they may still participate in the associated experience-sharing session.) This configuration may help to create the perception of an open audio communication channel.

In a further aspect, a server could also support a video-chat feature that is associated with an experience-sharing session. For example, some or all of the participants in a video chat could stream a low-resolution video feed. As such, participants in the video chat may be provided with a view of a number of these low-resolution video feeds on the same screen as the video from a sharer, along with a combined audio feed as described above. For instance, low-resolution video feeds from viewers and/or the sharer could be displayed to a participating viewer. Alternatively, the supporting server may determine when a certain participating device is transmitting speech from its user, and update which video or videos are displayed based on which participants are transmitting speech at the given point in time.

In either scenario above, and possibly in other scenarios, viewer video feeds may be formatted to capture the users themselves, so that the users can be seen as they speak. Further, the video from a given viewer or the sharer may be processed to include a text caption including, for example, the name of a given device's user or the location of device. Other processing may also be applied to video feeds in a video chat session.

In some embodiments, a video chat session may be established that rotates the role of sharer between different participating devices (with those devices that are not designated as the sharer at a given point in time acting as a viewer.) For example, when a number of wearable computers are involved in a rotating-sharer experience-sharing session, the supporting server system may analyze audio feeds from the participating wearable computers to determine which wearable computer is transmitting audio including the associated user's speech. Accordingly, the server system may select the video from this wearable computer and transmit the video to all the other participating wearable computers. The wearable computer may be de-selected when it is determined that speech is no longer being received from it. Alternatively, the wearable computer may be de-selected after waiting for a predetermined amount of time after it ceases transmission of speech.

In a further aspect, the video from some or all the wearable computers that participate in such a video chat session may capture the experience of the user that is wearing the respective wearable computer. Therefore, when a given wearable computer is selected, this wearable computer is acting as the sharer in the experience-sharing session, and all the other wearable computers are acting as viewers. Thus, as different wearable computers are selected, the role of the sharer in the experience-sharing session is passed between these wearable computers. In this scenario, the sharer in the experience-sharing session is updated such that the user who is speaking at a given point in time is sharing what they are seeing with the other users in the session.

In a variation on the above-described video-chat application, when multiple participants are acting a sharers and transmitting a share, individual viewers may be able to select which share they receive, such that different viewers may be concurrently receiving different shares.

In another variation on the above-described video-chat application, the experience-sharing session may have a “directing viewer” that may select which shares or shares will be displayed at any given time. This variation may be particularly useful in an application of a multi-sharer experience-sharing session, in which a number of viewers are all transmitting a share related to a certain event. For instance, each member of a football team could be equipped with a helmet-mounted camera. As such, all members of the team could act as sharers in a multi-sharer experience-sharing session by transmitting a real-time video feed from their respective helmet-mounted cameras. A directing viewer, could then select which video feeds to display at a given time. For example, at a given point in time, the directing viewer might select a video feed or feeds from a member or members that are involved in a play that is currently taking place.

In a further aspect of such an embodiment, the supporting server system may be configured to resolve conflicts if multiple devices transmit speech from their users simultaneously. Alternatively, the experience-sharing session interface for participants may be configured to display multiple video feeds at once (i.e., to create multiple simultaneous sharers in the experience-sharing session). For instance, if speech is received from multiple participating devices at once, a participating device may divide its display to show the video feeds from some or all of the devices from which speech is simultaneously received.

In a further aspect, a device that participates in an experience-sharing session, may store the share or portions of the share for future reference. For example, in a video-chat implementation, a participating device and/or a supporting server system may store the video and/or audio that is shared during the experience-sharing session. As another example, in a video-chat or voice-chat session, a participating device and/or a supporting server system may store a transcript of the audio from the session.

### Overview of Region of Interest Selection in an Experience-Sharing Session

In many instances, users may want to participate in an experience-sharing session via their mobile devices. However, streaming video and other media to mobile devices can be difficult due to bandwidth limitations. Further, users may have bandwidth quotas in their service plans, and this wish to conserve their bandwidth usage. For these and/or other reasons, it may be desirable to conserve bandwidth where possible. As such, exemplary methods may take advantage of the ability to identify a region of interest (ROI) in a share, which corresponds to what the sharer is focusing on, and then format the share so as to reduce the bandwidth required for portions of the share other than the ROI. Since viewers are more likely to be interested in what the sharer is focusing on, this type of formatting may help to reduce bandwidth requirements, without significantly impacting a viewer's enjoyment of the session.

For example, to conserve bandwidth, a wearable computing device may transmit the portion of the video that corresponds to the region of interest a high-resolution or format and the remainder of the video in a low-resolution format. In some embodiments, the high-resolution format takes relatively more bandwidth to transmit than the low-resolution format. Thus, the high-resolution format can be considered as a “high-bandwidth format” or “higher-bandwidth format,” while the low-resolution format can be considered as a “low-bandwidth format” or “lower-bandwidth format.” Alternatively, the portion outside of the region of interest might not be transmitted at all. In addition to video, the wearable computing device could capture and transmit an audio stream. The user, a remote viewer, or an automated function may identify a region of interest in the audio stream, such as a particular speaker.

In some embodiments, identifying the ROI, determining a portion of images in the share corresponding to the ROI, and/or formatting the images based on the determined portion can be performed in real-time. The images in the share can be transmitted as video data in real-time.

ROI functionality may be implemented in many other scenarios as well. For instance, in an experience-sharing session, a sharer might want to point out notable features of the environment. For example, in an experience sharing session during a scuba dive, a sharer might want to point out an interesting fish or coral formation. Additionally or alternatively, a viewer in the experience-sharing session might want to know what the sharer is focusing their attention on. In either case, one technique to point out notable features is to specify a region of interest (ROI) within the environment.

The region of interest could be defined either by the user of the wearable computing device or by one of the remote viewers. Additionally or alternatively, the sharing device may automatically specify the region of interest on behalf of its user, without any explicit instruction from the user. For example, consider a wearable computer that is configured with eye-tracking functionality, which is acting as a sharing device in an experience-sharing session. The wearable computer may use eye-tracking data to determine where its wearer is looking, or in other words, to determine an ROI in the wearer's field of view. A ROI indication may then be inserted into a video portion of the share at a location that corresponds to the ROI in the wearer's field of view. Other examples are also possible.

In a further aspect, the region of interest can be one or more specific objects shown in the video, such as the fish or coral formation in the scuba example mentioned above. In another example, the region of interest is delimited by a focus window, such as a square, rectangular, or circular window. The user or remote viewer may be able to adjust the size, shape, and/or location of the focus window, for example, using an interface in which the focus window overlays the video or overlays the wearer's view through the HMD, so that a desired region of interest is selected.

In some embodiments, the wearable computing device can receive request(s) to track object(s) with region(s) of interests during an experience sharing session, automatically track the object(s) during the experience sharing session, and maintain the corresponding region(s) of interest throughout a subsequent portion or entirety of the experience sharing session. After receiving the request(s) to track objects, the wearable computing device can receive corresponding request(s) to stop tracking object(s) during the experience sharing session, and, in response, delete any corresponding region(s) of interest.

In other embodiments, some or all regions of interest can be annotated with comments or annotations. The comments can appear as an annotation on or near the region of interest in a live or stored video portion of an electronic sharing session. The comments can be maintained throughout the electronic sharing session, or can fade from view after a pre-determined period of time (e.g., 10-60 seconds after the comment was entered). In particular embodiments, faded comments can be re-displayed upon request.

In an embodiment where a wearable computing device includes an HMD, the HMD may display an indication of the region of interest. For example, if the region of interest is an object, the HMD may display an arrow, an outline, or some other image superimposed on the user's field of view such that the object is indicated. If the region of interest is defined by a focus window, the HMD may display the focus window superimposed on the user's field of view so as to indicate the region of interest.

### Exemplary ESS System Architecture

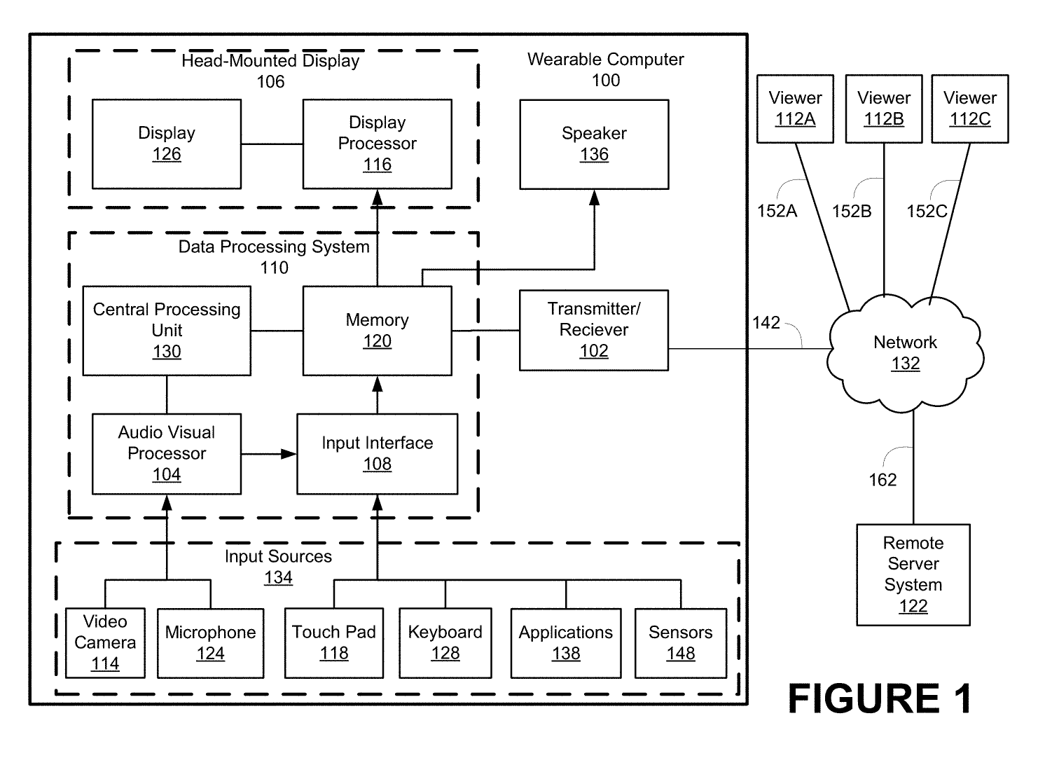

FIG. 1 is a simplified diagram of a sharing device, according to an exemplary embodiment. In particular, FIG. 1 shows a wearable computer 100 that is configured to serve as the sharer in an experience-sharing session. It should be understood, however, that other types of computing devices may be configured to provide similar sharing-device functions and/or may include similar components as those described in reference to wearable computer 100, without departing from the scope of the invention.

As shown, wearable computer 100 includes a head-mounted display (HMD) 106, several input sources 134, a data processing system, and a transmitter/receiver 102. FIG. 1 also indicates that a communicative link 142 could be established between the wearable computer 100 and a network. Further, the network could connect to a server 122 and one or more viewers 112A, 112B, and 112C through additional connections 162, 152A, 152B, and 152C.

An exemplary set of input sources 134 are shown in FIG. 1 as features of the wearable computer including: a video camera 114, a microphone 124, a touch pad 118, a keyboard 128, one or more applications 138, and other general sensors 148 (e.g. biometric sensors). The input sources 134 may be internal, as shown in FIG. 1, or the input sources 134 may be in part or entirely external. Additionally, the input sources 134 shown in FIG. 1 should not be considered exhaustive, necessary, or inseparable. Exemplary embodiments may exclude any of the exemplary set of input devices 134 and/or include one or more additional input devices that may add to an experience-sharing session.

The exemplary data processing system 110 may include a memory system 120, a central processing unit (CPU) 130, an input interface 108, and an audio visual (A/V) processor 104. The memory system 120 may be configured to receive data from the input sources 134 and/or the transmitter/receiver 102. The memory system 120 may also be configured to store received data and then distribute the received data to the CPU 130, the HMD 106, a set of one or more speakers 136, or to a remote device through the transmitter/receiver 102. The CPU 130 may be configured to detect a stream of data in the memory system 120 and control how the memory system distributes the stream of data. The input interface 108 may be configured to process a stream of data from the input sources 134 and then transmit the processed stream of data into the memory system 120. This processing of the stream of data converts a raw signal, coming directly from the input sources 134 or A/V processor 104, into a stream of data that other elements in the wearable computer 100, the viewers 112, and the server 122 can use. The A/V processor 104 may be configured perform audio and visual processing on one or more audio feeds from one or more microphones 124 and on one or more video feeds from one or more video cameras 114. The CPU 130 may be configured to control the audio and visual processing performed on the one or more audio feeds and the one or more video feeds. Examples of audio and video processing techniques, which may be performed by the A/V processor 104, will be given later.

The transmitter/receiver 102 may be configured to communicate with one or more remote devices through the communication network 132. Each connection made to the network (142, 152A, 152B, 152C, and 162) may be configured to support two-way communication and may be wired or wireless.

The HMD 106 may be configured to display visual objects derived from many types of visual multimedia, including video, text, graphics, pictures, application interfaces, and animations. In some embodiments, one or more speakers 136 may also present audio objects. Some embodiments of an HMD 106 may include a visual processor 116 to store and transmit a visual object to a physical display 126, which actually presents the visual object. The visual processor 116 may also edit the visual object for a variety of purposes. One purpose for editing a visual object may be to synchronize displaying of the visual object with presentation of an audio object to the one or more speakers 136. Another purpose for editing a visual object may be to compress the visual object to reduce load on the display. Still another purpose for editing a visual object may be to correlate displaying of the visual object with other visual objects currently displayed by the HMD 106.

While FIG. 1 illustrates a wearable computer configured to act as sharing device, it should be understood that a sharing device may take other forms. For example, a sharing device may be a mobile phone, a tablet computer, a personal computer, or any other computing device configured to provide the sharing device functionality described herein.

In general, it should be understood that any computing system or device described herein may include or have access to memory or data storage, which may take include a non-transitory computer-readable medium having program instructions stored thereon. Additionally, any computing system or device described herein may include or have access to one or more processors. As such, the program instructions stored on such a non-transitory computer-readable medium may be executable by at least one processor to carry out the functionality described herein.

Further, while not discussed in detail, it should be understood that the components of a computing device that serves as a viewing device in an experience-sharing session may be similar to those of a computing device that serves as a sharing device in an experience-sharing session. Further, a viewing device may take the form of any type of networked device capable of providing a media experience (e.g., audio and/or video), such as television, a game console, and/or a home theater system, among others.

### Exemplary Device Architecture

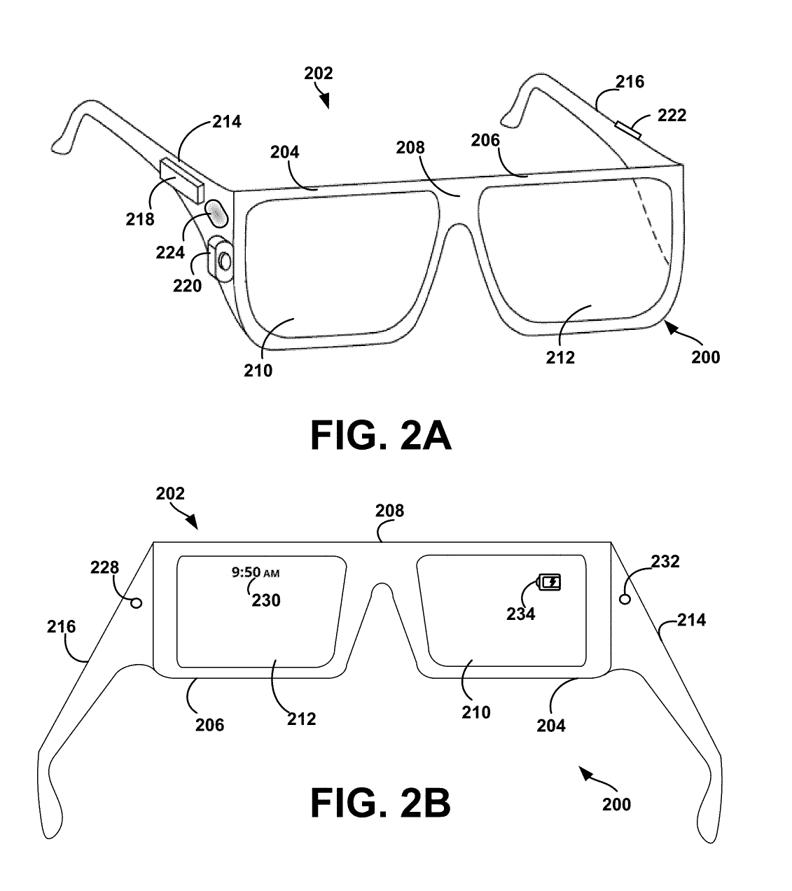

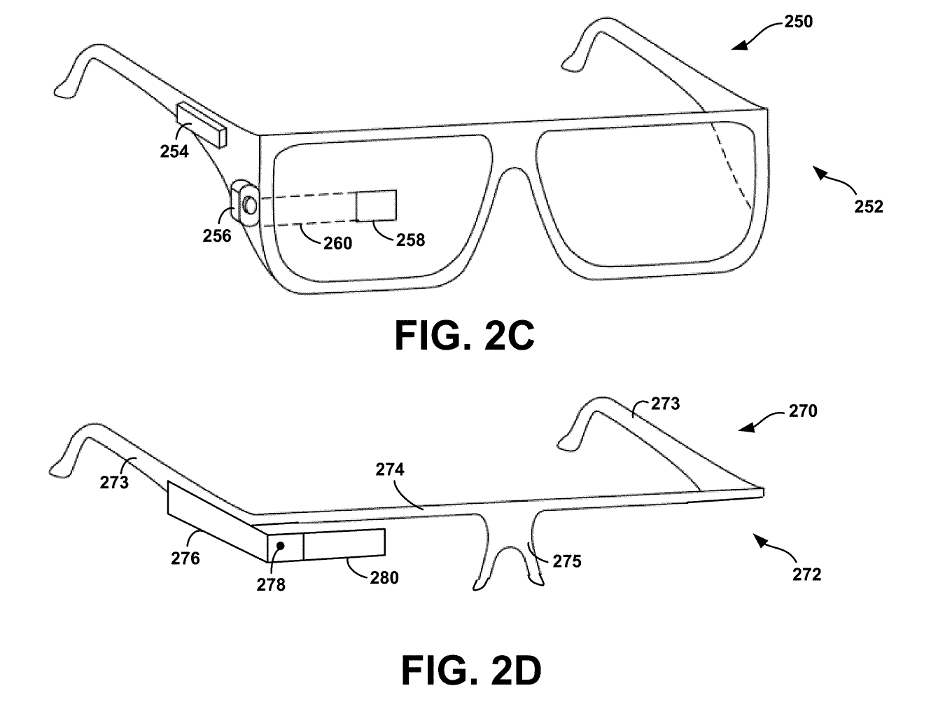

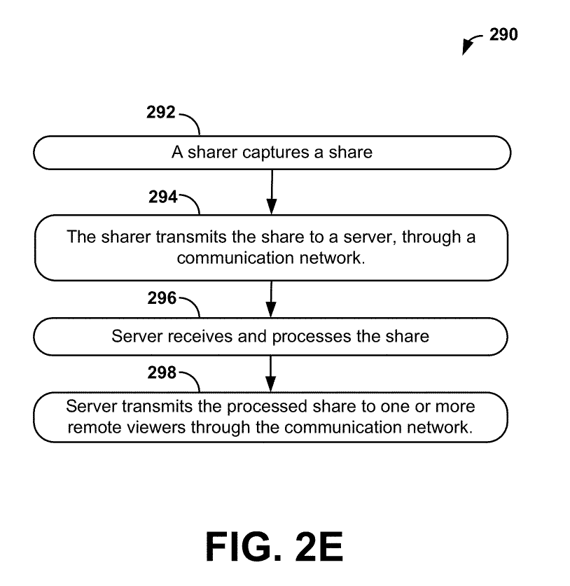

FIG. 2A illustrates an example of a wearable computing device. While FIG. 2A illustrates a head-mounted device 202 as an example of a wearable computing device, other types of wearable computing devices could additionally or alternatively be used. As illustrated in FIG. 2A, the head-mounted device 202 includes frame elements including lens-frames 204, 206 and a center frame support 208, lens elements 210, 212, and extending side-arms 214, 216. The center frame support 208 and the extending side-arms 214, 216 are configured to secure the head-mounted device 202 to a user's face via a user's nose and ears, respectively.

Each of the frame elements 204, 206, and 208 and the extending side-arms 214, 216 may be formed of a solid structure of plastic and/or metal, or may be formed of a hollow structure of similar material so as to allow wiring and component interconnects to be internally routed through the head-mounted device 202. Other materials may be possible as well.

One or more of each of the lens elements 210, 212 may be formed of any material that can suitably display a projected image or graphic. Each of the lens elements 210, 212 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 214, 216 may each be projections that extend away from the lens-frames 204, 206, respectively, and may be positioned behind a user's ears to secure the head-mounted device 202 to the user. The extending side-arms 214, 216 may further secure the head-mounted device 202 to the user by extending around a rear portion of the user's head. Additionally or alternatively, for example, the system 200 may connect to or be affixed within a head-mounted helmet structure. Other possibilities exist as well.

The system 200 may also include an on-board computing system 218, a video camera 220, a sensor 222, and a finger-operable touch pad 224. The on-board computing system 218 is shown to be positioned on the extending side-arm 214 of the head-mounted device 202; however, the on-board computing system 218 may be provided on other parts of the head-mounted device 202 or may be positioned remote from the head-mounted device 202 (e.g., the on-board computing system 218 could be wire- or wirelessly-connected to the head-mounted device 202). The on-board computing system 218 may include a processor and memory, for example. The on-board computing system 218 may be configured to receive and analyze data from the video camera 220 and the finger-operable touch pad 224 (and possibly from other sensory devices, user interfaces, or both) and generate images for output by the lens elements 210 and 212.

The video camera 220 is shown positioned on the extending side-arm 214 of the head-mounted device 202; however, the video camera 220 may be provided on other parts of the head-mounted device 202. The video camera 220 may be configured to capture images at various resolutions or at different frame rates. Many video cameras with a small form-factor, such as those used in cell phones or webcams, for example, may be incorporated into an example of the system 200.

Further, although FIG. 2A illustrates one video camera 220, more video cameras may be used, and each may be configured to capture the same view, or to capture different views. For example, the video camera 220 may be forward facing to capture at least a portion of the real-world view perceived by the user. This forward facing image captured by the video camera 220 may then be used to generate an augmented reality where computer generated images appear to interact with the real-world view perceived by the user.

In yet another example, wearable computing device 312 can include an inward-facing camera that tracks the user's eye movements. Thus, the region of interest could be defined based on the user's point of focus, for example, so as to correspond to the area within the user's foveal vision.

Additionally or alternatively, wearable computing device 312 may include one or more inward-facing light sources (e.g., infrared LEDs) and one or more inward-facing receivers such as photodetector(s) that can detect reflections of the inward-facing light sources from the eye. The manner in which beams of light from the inward-facing light sources reflect off the eye may vary depending upon the position of the iris. Accordingly, data collected by the receiver about the reflected beams of light may be used to determine and track the position of the iris, perhaps to determine an eye gaze vector from the back or fovea of the eye through the iris.

The sensor 222 is shown on the extending side-arm 216 of the head-mounted device 202; however, the sensor 222 may be positioned on other parts of the head-mounted device 202. The sensor 222 may include one or more of a gyroscope or an accelerometer, for example. Other sensing devices may be included within, or in addition to, the sensor 222 or other sensing functions may be performed by the sensor 222.

The finger-operable touch pad 224 is shown on the extending side-arm 214 of the head-mounted device 202. However, the finger-operable touch pad 224 may be positioned on other parts of the head-mounted device 202. Also, more than one finger-operable touch pad may be present on the head-mounted device 202. The finger-operable touch pad 224 may be used by a user to input commands. The finger-operable touch pad 224 may sense at least one of a position and a movement of a finger via capacitive sensing, resistance sensing, or a surface acoustic wave process, among other possibilities. The finger-operable touch pad 224 may be capable of sensing finger movement in a direction parallel or planar to the pad surface, in a direction normal to the pad surface, or both, and may also be capable of sensing a level of pressure applied to the pad surface. The finger-operable touch pad 224 may be formed of one or more translucent or transparent insulating layers and one or more translucent or transparent conducting layers. Edges of the finger-operable touch pad 224 may be formed to have a raised, indented, or roughened surface, so as to provide tactile feedback to a user when the user's finger reaches the edge, or other area, of the finger-operable touch pad 224. If more than one finger-operable touch pad is present, each finger-operable touch pad may be operated independently, and may provide a different function.

FIG. 2B illustrates an alternate view of the system 200 illustrated in FIG. 2A. As shown in FIG. 2B, the lens elements 210, 212 may act as display elements. The head-mounted device 202 may include a first projector 228 coupled to an inside surface of the extending side-arm 216 and configured to project a display 230 onto an inside surface of the lens element 212. Additionally or alternatively, a second projector 232 may be coupled to an inside surface of the extending side-arm 214 and configured to project a display 234 onto an inside surface of the lens element 210.

The lens elements 210, 212 may act as a combiner in a light projection system and may include a coating that reflects the light projected onto them from the projectors 228, 232. In some embodiments, a reflective coating may not be used (e.g., when the projectors 228, 232 are scanning laser devices).

In alternative embodiments, other types of display elements may also be used. For example, the lens elements 210, 212 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 204, 206 for driving such a matrix display. Alternatively or additionally, a laser or LED source and scanning system could be used to draw a raster display directly onto the retina of one or more of the user's eyes. Other possibilities exist as well.

FIG. 2C illustrates an example system for receiving, transmitting, and displaying data. The system 250 is shown in the form of a wearable computing device 252. The wearable computing device 252 may include frame elements and side-arms such as those described with respect to FIGS. 2A and 2B. The wearable computing device 252 may additionally include an on-board computing system 254 and a video camera 256, such as those described with respect to FIGS. 2A and 2B. The video camera 256 is shown mounted on a frame of the wearable computing device 252; however, the video camera 256 may be mounted at other positions as well.

As shown in FIG. 2C, the wearable computing device 252 may include a single display 258 which may be coupled to the device. The display 258 may be formed on one of the lens elements of the wearable computing device 252, such as a lens element described with respect to FIGS. 2A and 2B, and may be configured to overlay computer-generated graphics in the user's view of the physical world. The display 258 is shown to be provided in a center of a lens of the wearable computing device 252; however, the display 258 may be provided in other positions. The display 258 is controllable via the computing system 254 that is coupled to the display 258 via an optical waveguide 260.

FIG. 2D illustrates an example system for receiving, transmitting, and displaying data. The system 270 is shown in the form of a wearable computing device 272. The wearable computing device 272 may include side-arms 273, a center frame support 274, and a bridge portion with nosepiece 275. In the example shown in FIG. 2D, the center frame support 274 connects the side-arms 273. The wearable computing device 272 does not include lens-frames containing lens elements. The wearable computing device 272 may additionally include an on-board computing system 276 and a video camera 278, such as those described with respect to FIGS. 2A and 2B.

The wearable computing device 272 may include a single lens element 280 that may be coupled to one of the side-arms 273 or the center frame support 274. The lens element 280 may include a display such as the display described with reference to FIGS. 2A and 2B, and may be configured to overlay computer-generated graphics upon the user's view of the physical world. In one example, the single lens element 280 may be coupled to the inner side (i.e., the side exposed to a portion of a user's head when worn by the user) of the extending side-arm 273. The single lens element 280 may be positioned in front of or proximate to a user's eye when the wearable computing device 272 is worn by a user. For example, the single lens element 280 may be positioned below the center frame support 274, as shown in FIG. 2D.

As described in the previous section and shown in FIG. 1, some exemplary embodiments may include a set of audio devices, including one or more speakers and/or one or more microphones. The set of audio devices may be integrated in a wearable computer 202, 250, 270 or may be externally connected to a wearable computer 202, 250, 270 through a physical wired connection or through a wireless radio connection.

### Cloud-Based Experience Sharing

In some exemplary embodiments a remote server may help reduce the sharer's processing load. In such embodiments, the sharing device may send the share to a remote, cloud-based serving system, which may function to distribute the share to the appropriate viewing devices. As part of a cloud-based implementation, the sharer may communicate with the server through a wireless connection, through a wired connection, or through a network of wireless and/or wired connections. The server may likewise communicate with the one or more viewers through a wireless connection, through a wired connection, or through a network of wireless and/or wired connections. The server may then receive, process, store, and/or transmit both the share from the sharer and comments from the viewers.

FIG. 2E is a flow chart illustrating a cloud-based method, according to an exemplary embodiment. In particular, method 290 may include the sharer capturing a share 292. Also, the sharer may transmit the share to a server through a communication network 294. Next, the server may receive and process the share 296. Then, the server may transmit the processed share to at least one viewer 298.

An experience-sharing server may process a share in various ways before sending the share to a given viewer. For example, the server may format media components of a share to help adjust for a particular viewer's needs or preferences. For instance, consider a viewer that is participating in an experience-sharing session via a website that uses a specific video format. As such, when the share includes a video, the experience-sharing server may format the video in the specific video format used by the web site before transmitting the video to this viewer. In another example, if a viewer is a PDA that can only play audio feeds in a specific audio format, the server may format an audio portion of a share in the specific audio format used by the PDA before transmitting the audio portion to this viewer. Other examples of formatting a share (or a portion of a share) for a given viewer are also possible. Further, in some instances, the ES server may format the same share in a different manner for different viewers in the same experience-sharing session.

Further, in some instances, an experience-sharing server may compress a share or a portion of a share before transmitting the share to a viewer. For instance, if a server receives a high-resolution share, it may be advantageous for the server to compress the share before transmitting it to the one or more viewers. For example, if a connection between a server and a certain viewer runs too slowly for real-time transmission of the high-resolution share, the server may temporally or spatially compress the share and send the compressed share to the viewer. As another example, if a viewer requires a slower frame rate for video feeds, a server may temporally compress a share by removing extra frames before transmitting the share to that viewer. And as another example, the server may be configured to save bandwidth by downsampling a video before sending the stream to a viewer that can only handle a low-resolution image. Additionally or alternatively, the server may be configured to perform pre-processing on the video itself, e.g., by combining multiple video sources into a single feed, or by performing near-real-time transcription (closed captions) and/or translation.

Yet further, an experiencing-sharing server may decompress a share, which may help to enhance the quality of an experience-sharing session. In some embodiments, to reduce transmission load on the connection between a sharer and a server, the sharer may compress a share before sending the share to the server. If transmission load is less of a concern for the connection between the server and one or more viewers, the server may decompress the share before sending it to the one or more viewers. For example, if a sharer uses a lossy spatial compression algorithm to compress a share before transmitting the share to a server, the server may apply a super-resolution algorithm (an algorithm which estimates sub-pixel motion, increasing the perceived spatial resolution of an image) to decompress the share before transmitting the share to the one or more viewers. In another implementation, the sharer may use a lossless data compression algorithm to compress a share before transmission to the server, and the server may apply a corresponding lossless decompression algorithm to the share so that the share may be usable by the viewer.

### Identifying a Region of Interest in a Share

As noted above, in order to format a share so as to reduce bandwidth requirements, and/or to enhance the quality of experience sharing, an exemplary method may identify a region-of interest in a share. Some techniques for identifying a region of interest may involve using of eye-tracking data to determine where a user of a sharing device is looking, specifying this area as a region of interest, and then formatting the share so as to reduce the data size of the portion of the share outside of the region of interest.

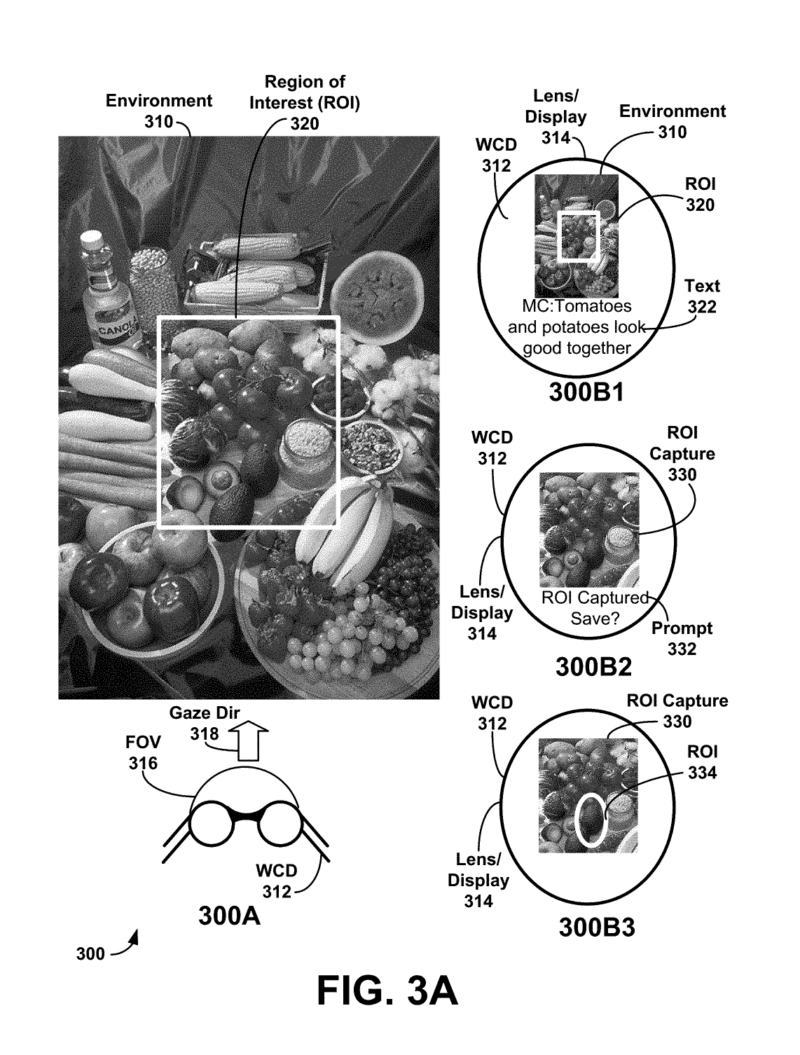

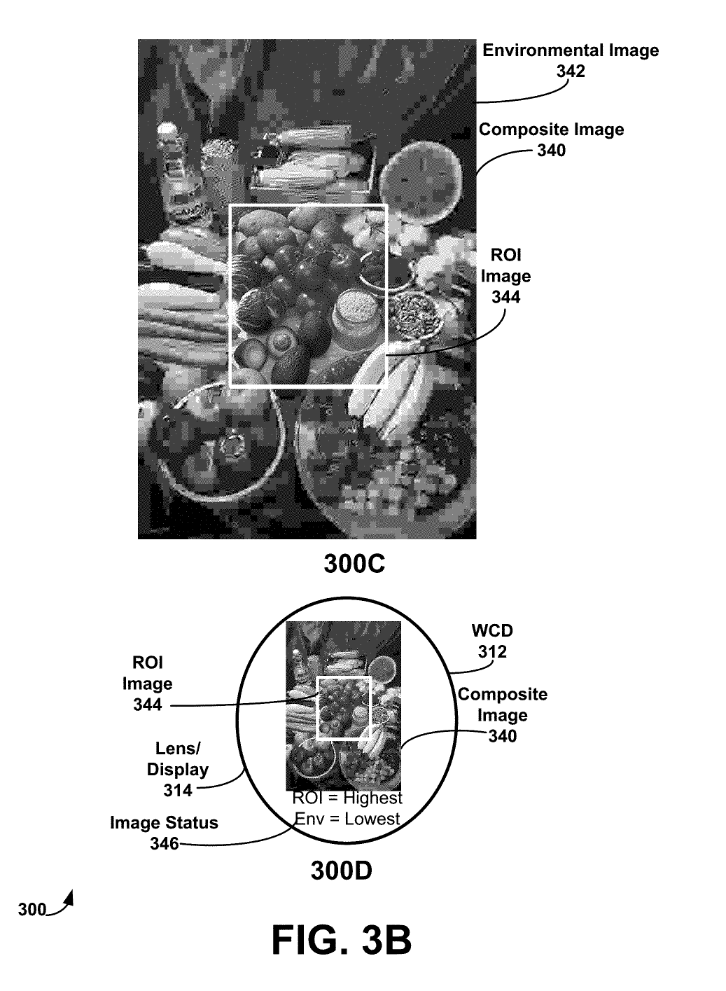

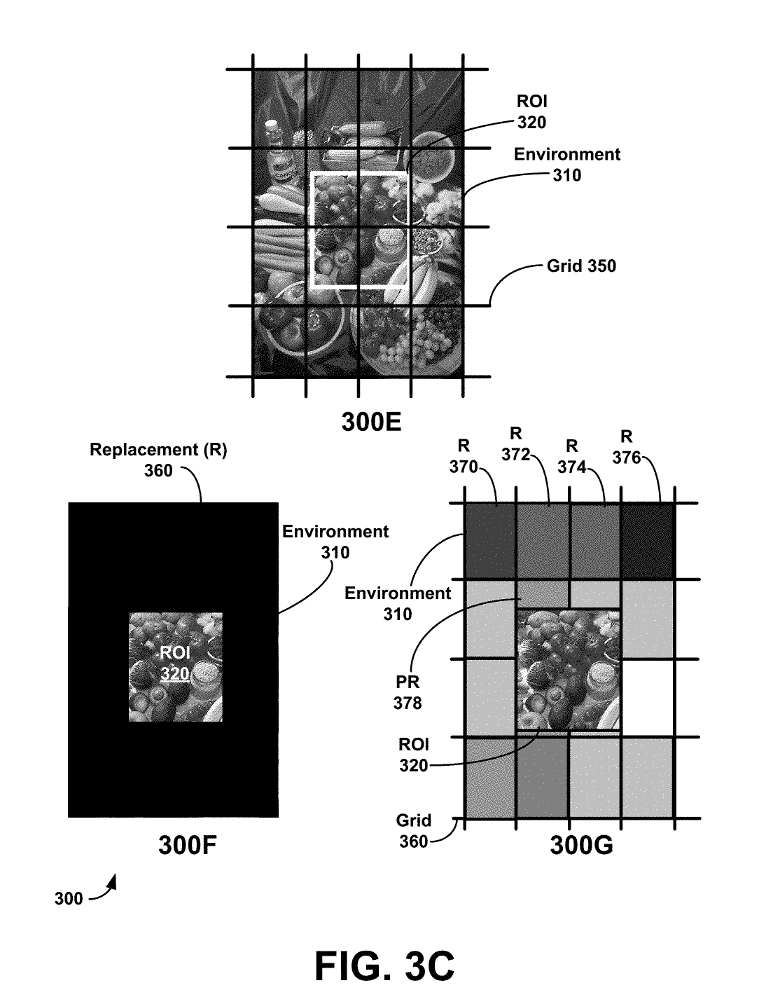

Other techniques for identifying the region of interest may involve receiving input from a user that specifies a region of interest within the user's field of view. Once specified, images and/or video can concentrate on the region of interest. For example, images and/or video of an experience sharing session can utilize a higher-resolution portion of the image or video within the region of interest than utilized outside of the region of interest. FIGS. 3A-3C together depict a scenario 300 for specifying regions of interest and generating various images concentrated on the region of interest.

FIG. 3A depicts use of wearable computing device (WCD) 312 gazing at environment 310 in a gaze direction 318 within field of view (FOV) 316. Wearable computing device 310 can be configured to use gaze direction 318 to implicitly specify region of interest (ROI) 320 within environment 310.

Once region of interest 320 is specified, WCD 310 and/or server 122 can generate displays of the environment based on the region of interest. At 300A of FIG. 3A, wearable computing device 312 indicates region of interest 320 of environment 310 using a white rectangle approximately centered in environment 310. One or more images of the region of interest can be indicated, captured, shared, and/or or stored for later use. At 300B1 of FIG. 3A, wearable computing device 312 can uses a lens/display 314 to display an image of environment 310 with an indicator outlining region of interest 320, such as the white rectangle depicted in FIG. 3A. In some embodiments, wearable computing device 312 can generate the indicator for region of interest 320, while in other embodiments, a server, such as server 122, can generate indicator(s) of region(s) of interest.

In an experience-sharing session, an image containing both an environment and an outline of region of interest can be shared with viewers to show interesting features of the environment from the sharer's point of view. For example, the image shown at 300B1 can be shared with viewers of an electronic sharing system. FIG. 3A at 300B1 shows text 322 of “Tomatoes and potatoes look good together” regarding region of interest (ROI) 320. Text 322 also shows an identifier “MC” to indicate an author of the text to help identify both text 322 and region of interest 320 to viewers of the experience-sharing session.

At 300B2 of FIG. 3A, wearable computing device 312 has captured region of interest 310 and is displaying a capture of region of interest 330 using lens/display 314. FIG. 3A shows that capture of region of interest 330 at 300B2 is displayed relatively larger than region of interest 320 at 300B1. Displaying a relatively-larger region(s) of interest permits wearable computing device 312 to enlarge and perhaps otherwise enhance display of feature(s) of interest. In particular, enlarging or “zooming in on” features of interest can permit a wearer of wearable computing device 312 (e.g. the sharer of an experience-sharing session sharing the image shown at 300B1) and/or viewers of an experience-sharing session to see additional features not apparent before specifying the region of interest.

FIG. 3A at 300B2 also shows prompt 332 both informing the wearer of wearable computing device 312 that region of interest 320 has been captured and requesting that the wearer provide instructions as to whether or not to save the region of interest capture 330. Along with or instead of saving region of interest capture 330, the wearer can instruct wearable computing device 312 to perform other operations utilizing region of interest capture 330, such as but not limited to: e-mailing or otherwise sending a copy of region of interest capture 330 to one or more other persons presumably outside of an experience-sharing session, to remove region of interest capture 330, and enhance region of interest capture 330. In some embodiments, wearable computing device 312 can be instructed by communicating instructions via an experience-sharing session.

Sub-regions of interest can be specified within regions of interest. At 300B3 of FIG. 3A, wearable computing device 312 is shown displaying a white oval specifying region of interest 334 within capture of region of interest 330. That is, region of interest 334 is a sub-region of environment. In other scenarios not depicted in the Figures, sub-sub-regions, sub-sub-sub regions, etc. can be specified using the techniques disclosed herein. The operations of utilizing region of interest 320 disclosed herein can also be applied to region of interest 334; e.g., region of interest 334 can be enlarged, captured, emailed, enhance, removed, or shared as part of an experience-sharing session.

In some embodiments not pictured, wearable computing device 312 can include one or more external cameras. Each external camera can be partially or completely controlled by wearable computing device 312. For example, an external camera can be moved using servo motors.

As another example, the wearable computing device can be configured to remotely control a remotely-controllable camera so activate/deactivate the external camera, zoom in/zoom out, take single and/or motion pictures, use flashlights, and/or other functionality of the external camera. In these embodiments, the wearer and/or one or more sharers, either local or remote, can control a position, view angle, zoom, and/or other functionality of the camera, perhaps communicating these controls via an experience-sharing session. The wearable computing device can control multiple cameras; for example, a first camera with a wide field of view and relatively low resolution and a second camera under servo/remote control with a smaller field of view and higher resolution.

### Formatting a Share Based on a Region of Interest

Once a region (or sub-region) of interest is specified, media content in the share can be formatted so as to concentrate on the region of interest. For example, images and/or video of an experience sharing session can include one or more “composite images” that utilize a higher-resolution portion of the image or video within the region of interest than utilized outside of the region of interest. These composite images can be generated both to save bandwidth and to draw a viewer's attention to the region of interest. For example, a composite image can be generated from two images: a “ROI image” of the region of interest and an “environmental image” which is an image of the environment outside of the region of interest representative of the wearer's field of view. In some embodiments, the ROI image can have relatively-higher resolution (e.g., take more pixels/inch) than the environmental image.

FIG. 3B at 300C shows composite image 340 combining environmental image 342 and ROI image 344, with a white boundary shown around ROI image 344 for clarity's sake. Environmental image 342 is a lower-resolution version of an image of environment 310 that is outside of region of interest 320, while ROI image 344 is a full-resolution version of the image of environment 310 that is inside region of interest 320. In the example shown in FIG. 3B, environmental image 342 and ROI image 344 respectively require approximately 1% and 22% of the size of the image of environment 310 shown in FIG. 3A. Assuming both environmental image 342 and ROI image 344 are transmitted, the combination of both images may require approximately 23% of the bandwidth required to transmit an image of environment 310 shown in FIG. 3A.

FIG. 3C at 300G shows wearable computing device 312 using lens/display 314 to display composite image 380 that combines environmental image 382 and ROI image 384. Wearable computing device 312 also shows image status 386 to indicate that ROI image 384 utilizes the “Highest” amount of storage and that environmental image 382 utilizes the “Lowest” amount of storage to save and consequently transmit each image.

Some additional bandwidth savings may be obtained by replacing the portion of environmental image 342 that overlaps ROI image 344 with ROI image 344, thus generating composite image 340. Then, by only transmitting only composite image 340, the bandwidth required to transmit the portion of environmental image 342 that overlaps ROI image 344 can be saved.

To further preserve bandwidth, still lower resolution versions of an environmental image can be utilized. At 300E of FIG. 3C, grid 360 overlays environment 310 and region of interest 320. Grid 350 is shown in FIG. 3C as being a 4×4 grid. The techniques regarding grid 350 disclosed herein apply equally to differently sized grids larger than 1×1 usable in other embodiments and scenarios not specifically mentioned herein.

For the example of scenario 300, suppose that the size of region of interest 320 as shown in FIG. 3B is A % of the size of environment 310—in this example, A is approximately 22%. More generally, suppose that an image of region of interest 320 takes B % of the bandwidth to transmit via wearable computing device 312 compared to transmitting a full image of environment 310, where B is less than 100%. Then, BP %=(100-B) % of the bandwidth required to transmit environment 310 can be preserved by transmitting just the image of region of interest 320 rather than the full image of environment 310.

In some embodiments, identifying the region of interest, determining a first portion in image(s) that correspond to the region of interest and a second portion of the image(s) that is not in the first portion, and/or formatting the image(s) based on the determined portion(s) of the image(s) can be performed in real-time. The formatted image(s) can be transmitted as video data in real-time.

At 300F of FIG. 3C, region of interest 320 has been cropped, or cut out of, environment 310. After cropping, an image of region of interest 320 can be sent alone to preserve BP % of bandwidth. With a small amount of additional bandwidth, the size of environment 310 and location, shape, and size(s) of region of interest 320 within environment 310 can be transmitted as well, to permit display of the image of region of interest 320 in a correct relative position within environment 310.

For example, suppose that each grid cell in grid 340 is 100×150 pixels, and so the size of environment 310 is 400×600 pixels. Continuing this example, suppose the respective locations of the upper-left-hand corner and the location of the lower-right-hand corner of region of interest 320 are at pixel locations (108, 200) and (192, 262) of environment 310, with pixel location (0, 0) indicating the upper-left-hand corner of environment 310 and pixel location (400, 600) indicating the lower-right-hand corner of environment 310.

Then, with this additional location information, a receiving device can display region of interest 320 in the relative position captured within environment 310. For example, upon receiving size information for environment 310 of 600×400 pixels, the receiving device can initialize a display area or corresponding stored image of 600×400 to one or more predetermined replacement pixel-color values. Pixel-color values are specified herein as a triple (R, G, B), where R=an amount of red color, G=an amount of green color, and B=an amount of blue color, and with each of R, G, and B specified using a value between 0 (no color added) and 255 (maximum amount of color added).

FIG. 3C at 300F shows an example replacement 360 using a predetermined pixel-color value of (0, 0, 0) (black). Each color of light is added to determine the final pixel color. Then, upon receiving the pixel locations of (108, 200) and (192, 262) for a rectangular region of interest 320, the receiving device can overlay the rectangle of pixel locations between (108, 200) and (192, 262) with the image data for region of interest 320, such as also shown at 300B of FIG. 3A. Showing regions of interest in the relative positions in which they were captured can help a viewer locate a region of interest within the environment, while at the same time using less bandwidth than when a full image of the environment is transmitted.

Additional information about the environment can be provided by adding relatively small amounts of additional bandwidth. For example, at 300G of FIG. 3C, the single predetermined replacement value 360 shown at 300F has been replaced with one replacement value per grid cell of grid 340, with grid 340 is shown using black lines. FIG. 3C at 300G shows the top row of grid 340 overlaying environment 320 with example replacement (R) pixel-color values for R 370=(65, 65, 65), R 372=(100, 100, 100), R 374=(100, 100, 100), and R 376=(65, 65, 65). Other values, perhaps determined by averaging some or all of the pixel values within a grid cell to determine an average pixel value within the grid cell, can be used to provide a replacement value for a grid cell. For grid cells that also include part of or the entire region of interest, one or more partial replacement (PR) values can be determined. For example, partial replacement 378 has a pixel-color value of (150, 150, 150) as shown in at 300F at FIG. 3C.

### Specification of a Region of Interest by a User

As noted above, a region of interest may also be indicated via explicit user instruction. In particular, a sharing device or a viewing device may receive explicit instructions to select and/or control a certain region of interest. Further, when a sharing device receives an explicit selection of a region of interest, the sharing device may relay the selection to the experience-sharing server, which may then format the share for one or more viewers based on the region of interest. Similarly, when a viewing device receives an explicit selection of a region of interest, the viewing device may relay the selection to the experience-sharing server. In this case, the server may then format the share for the viewing device based on the selected region of interest and/or may indicate the region of interest to the sharing device in the session.

In a further aspect, the explicit instructions may specify parameters to select a region of interest and/or actions to take in association with the selected region of interest. For example, the instructions may indicate to select regions of interest based on features within an environment, to perform searches based on information found within the environment, to show indicators of regions of interest, to change the display of the region of interest and/or environmental image, and/or to change additional display attributes. The instructions may include other parameters and/or specify other actions, without departing from the scope of the invention.

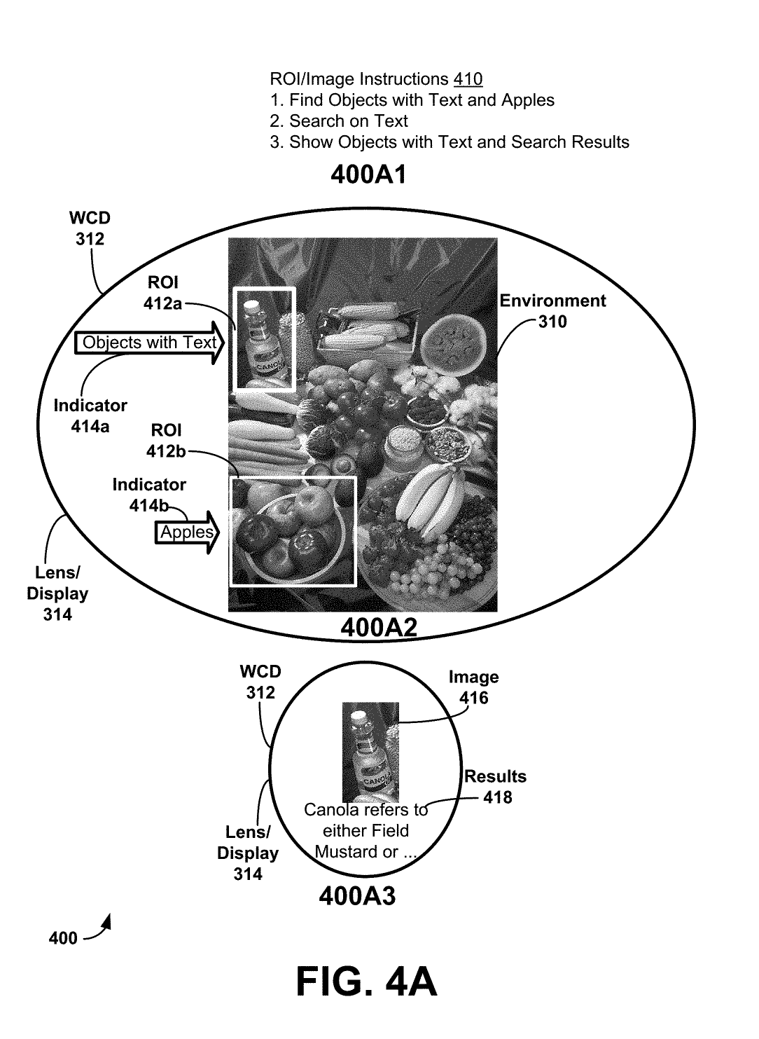

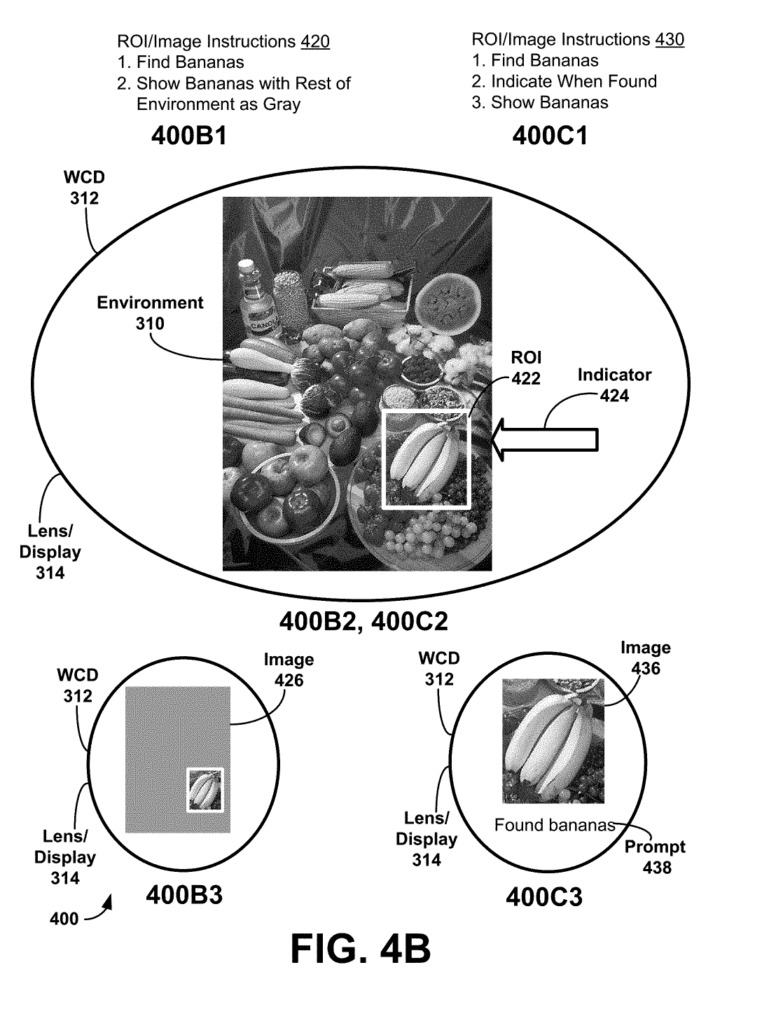

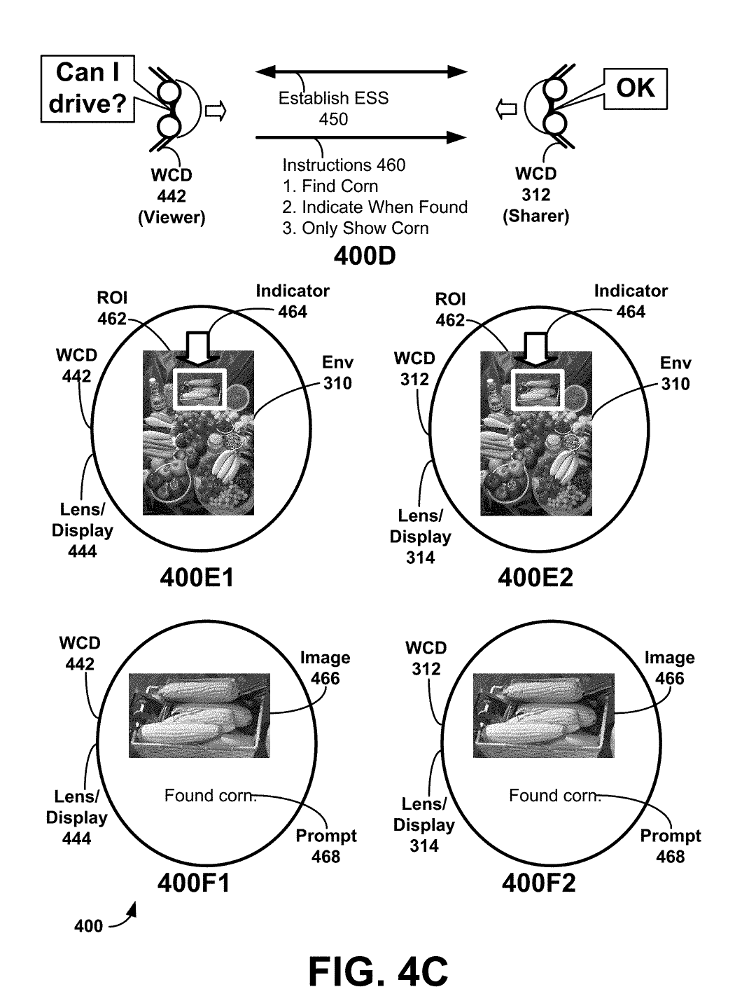

FIGS. 4A-4C illustrate scenario 400 where a wearable computing device carries out various instructions to control a region of interest and/or image, in accordance with an embodiment. Scenario 400 begins with wearable computing device 312 gazing at environment 310, such as shown in FIG. 3A. At 400A1 of FIG. 4A, instructions 410 are provided to wearable computing device 312 to control regions of interest and provide additional information related to the regions of interest. FIG. 4A shows that instructions 410 include “1. Find Objects with Text and Apples”, “2. Search on Text”, and “3. Show Objects with Text and Search Results”.

The instructions can be provided to wearable computing device 312 via voice input(s), textual input(s), gesture(s), network interface(s), combinations of these inputs thereof, and by other techniques for providing input to wearable computing device 312. The instructions can be provided as part of an experience sharing session with wearable computing device 312. In particular, the instructions can be provided to a server, such as server 122, to control display of a video feed for the experience sharing session, perhaps provided to a viewer of the experience sharing session. If multiple viewers are watching the experience sharing session, then the server can customize the views of the experience sharing session by receiving explicit instructions to control a region of interest and/or imagery from some or all of the viewers, and carrying out those instructions to control the video feeds sent to the multiple viewers.

Upon receiving instructions 410, wearable computing device 312 can execute the instructions. The first of instructions 400 “Find Objects in Text and Apples” can be performed by wearable computing device 312 capturing an image of environment 310 and scanning the image for text, such as the word “Canola” shown in environment 310. Upon finding the text “Canola”, wearable computing device 312 can utilize one or more image processing or other techniques to determine object(s) associated with the text “Canola.” For example, wearable computing device 312 can look for boundaries of an object that contains the text “Canola.”

Then, wearable computing device can scan environment 310 for apples. For example, wearable computing device 312 can scan for objects shaped like apples, perform search(es) for image(s) of apples and compare part or all of the resulting images with part or all of the image of environment 310, or via other techniques.

In scenario 400, in response to the “Find Objects with Text and Apples” instruction, wearable computing device 312 has found two objects: (1) a canola oil bottle with the text “Canola” and (2) a basket of apples. FIG. 4A at 400A2 shows that wearable computing device 312 utilizes two techniques to show the found canola oil bottle: one technique is to set region of interest 412a to a rectangle that contains the canola oil bottle, and another technique is to provide indicator 414a to point out the canola oil bottle within environment 310. As there are multiple regions of interest, indicator 414a can include text of “Objects with Text” indicating that the “Objects with Text” part of the “Find” instruction lead to selection of region of interest 412a. Similarly, region of interest 412b is set to a rectangle that contains the basket of apples, and indicator 414b with text “Apples” points out the basket of apples within environment 310.

Lens/display 314 has been enlarged in FIG. 4A at 400A2 to better depict environment 310, regions of interest 412a, 412b, and indicators 414a, 414b.

In scenario 400, wearable computing device 312 then executes the remaining two commands “Search on Text” and “Show Objects with Text and Search Results.” To execute the “Search on Text” command, wearable computing device 312 can generate queries for one or more search engines, search tools, databases, and/or other sources that include the text “Canola.” Upon generating these queries, wearable computing device 312 can communicate the queries as needed, and, in response, receives search results based on the queries.

At 400A3 of FIG. 4A, wearable computing device 312 utilizes lens/display 314 to display image 416 and results 418 in response to the “Show Objects with Text and Search Results” command. To execute the “Show Objects with Text and Search Results” command, wearable computing device 312 can capture an ROI image for region of interest 412, and display the ROI image as image 416 and the received search results as results 418. In some embodiments, image 416 can be enlarged and/or otherwise enhanced when displayed on lens/display 314.

Scenario 400 continues on FIG. 4B at 400B1, where instructions 420 are provided to wearable computing device 312 to control region(s) of interest and displayed image(s). FIG. 4B shows that instructions 420 include “1. Find Bananas” and “2. Show Bananas with Rest of Environment as Gray”. The instructions can be provided to wearable computing device 312 and/or a server, such as server 122, using any and all of the techniques for providing input discussed above for instructions 410.

Upon receiving instructions 420, wearable computing device 312 can execute the instructions. The first of instructions 400 “Find Bananas” can be performed by wearable computing device 312 capturing an image of environment 310 and scanning the image for shapes that appear to be bananas. For example, wearable computing device 312 can scan for objects shaped like bananas, perform search(es) for image(s) of bananas and compare part or all of the resulting images with part or all of the image of environment 310, or via other techniques. In scenario 400, wearable computing device finds bananas in environment 310.

FIG. 4B at 400B2 shows that wearable computing device 312 has both set region of interest 422 to a rectangle that contains the bananas, and provided indicator 414 to point out the bananas within environment 310. Lens/display 314 has been enlarged in FIG. 4B at 400A2 to better depict environment 310, region of interest 422, and indicator 424.

In scenario 400, wearable computing device 312 then executes the second instruction of instructions 420: “Show Bananas with Rest of Environment as Gray.” In response, at 400B3 of FIG. 4B, wearable computing device 312 utilizes lens/display 314 to display image 426. To execute the “Only Show Object and Search Results” command, wearable computing device 312 can capture an ROI image for region of interest 422, and display the ROI image as located within environment including a replacement “gray” value, utilizing the techniques discussed above in the context of FIG. 3B. In some embodiments, image 426 can be enlarged and/or otherwise enhanced when displayed on lens/display 314.

Scenario 400 continues on FIG. 4B at 400C1, where instructions 430 are provided to wearable computing device 312. FIG. 4B shows that instructions 430 include “1. Find Bananas”, “2. Indicate When Found”, and “3. Show Bananas”. The instructions can be provided to wearable computing device 312 and/or a server, such as server 112, using any and all of the techniques for providing input discussed above for instructions 410.

Upon receiving instructions 420, wearable computing device 312 can execute the instructions. The first of instructions 400 “Find Bananas” can be performed by wearable computing device 312 as discussed above for 400B2 of FIG. 4B. FIG. 4B shows that 400B2 and 400C2 involve identical processing by with the “400B2, 400C2” label under the enlarged version of lens/display 314 in the middle of FIG. 4B.

In scenario 400, wearable computing device 312 then executes the “Indicate When Found” and “Show Bananas” instructions of instructions 430. In response, at 400B3 of FIG. 4B, wearable computing device 312 utilizes lens/display 314 to display image 436 and prompt 438. To execute the “Indicate When Found” instruction, wearable computing device 312 can instruct lens/display 314 to display prompt 438, shown in FIG. 4B as “Found bananas.” To execute the “Show Bananas” command, wearable computing device 312 can capture an ROI image for region of interest 422, and display the ROI image as image 436 above prompt 438, as shown in FIG. 4B. In some embodiments, image 436 can be enlarged and/or otherwise enhanced when displayed on lens/display 314. In other embodiments, when executing the “Show Bananas” command, lens/display 314 can remove prompt 438 from lens/display 314.

Scenario 400 continues on FIG. 4C at 400D, where a wearer of wearable computing device 442 asks a wearer of wearable computing device 312 “Can I drive?”; that is, can the wearer of wearable computing device 442 control wearable computing device 312. In scenario 400, the wearer of wearable computing device 312 agrees to permit the wearer of wearable computing device 442 control wearable computing device 312.

Wearable computing device 442 and wearable computing device 312 then establish experience sharing session 450 (if not already established). Then, wearable computing device 442 sends instructions 460 to wearable computing device 312. As shown in FIG. 4C, instructions 460 include “1. Find Corn”, “2. Indicate When Found”, and “3. Show Corn.” The instructions can be input into wearable computing device 442 using any and all of the techniques for providing input discussed above for instructions 410, and then communicated using experience sharing session 450.

In scenarios not shown in the Figures, the wearer of wearable computing device 442 shares an experience sharing session shared from wearable computing device 312 via a server, such as server 112. For example, in response to a request to establish an experience sharing session for wearable computing device 442 to view the share generated by wearable computing device 312, the server can provide a full video feed of the experience sharing session 450. Then, the server can receive instructions 460 from wearable computing device 442 to control the video feed, change the video feed based on instructions 442, and provide the changed video feed to wearable computing device 442.

In embodiments not shown in FIG. 4C, wearable computing device 442 can directly control wearable computing device 312 using a “remote wearable computing device” interface along with or instead of providing instructions 460 to wearable computing device 312. For example, wearable computing device 442 can provide the remote wearable computing device interface by receiving current display information from wearable computing device 312, generate a corresponding display of wearable computing device 312 on wearable computing device 442, and enable use a touchpad and other input devices on wearable computing device 442 to directly control wearable computing device 312.

As an example use of the remote wearable computing device interface, wearable computing device 442 can select the corresponding display of wearable computing device 312 and use a touchpad or other device to generate the text “Hello” within the corresponding display. In response, wearable computing device 442 can send instructions to wearable computing device 312 to display the text “Hello” as indicated in the corresponding display. Many other examples of use of a remote wearable computing device interface are possible as well.

Upon receiving instructions 460, wearable computing device 312 can execute the instructions. The “Find Corn” instruction of instructions 460 can be performed by wearable computing device 312 as discussed above for 400B2 of FIG. 4B. FIG. 4C shows the results of the Find Corn instruction on wearable computing device 312 at 400E2, and as shown on wearable computing device 442, via experience sharing session 450, at 400E1. FIG. 4C shows that the displays on both lens/display 314 of wearable computing device 312 and on both lens/display 444 of wearable computing device 442 are identical. Both lens/display 314 and lens/display 444 are depicted in FIG. 4C as displaying environment 310 with a rectangular region of interest 462 that contains corn found by searching environment 310, and indicator 464 to point out the corn within environment 310.

In scenario 400, wearable computing device 312 then executes the “Indicate When Found” and “Only Show Corn” instructions of instructions 430. In response, at 400F2 of FIG. 4B, wearable computing device 312 utilizes lens/display 314 to display image 466 and prompt 468. Also, as shown on at 400F1, wearable computing device 442, via experience sharing session 450, utilizes lens/display 444 to display image 466 and prompt 468 of “Found corn”. FIG. 4C shows that image 466 is an ROI image of ROI 462 and that prompt 468 is “Found corn.” In some embodiments, image 466 can be enlarged and/or otherwise enhanced when displayed on lens/display 314 and/or lens/display 444.

### Snapping-to Objects of Interest

In some cases, a viewer or a sharer of an experience sharing session may wish to explicitly request that a region of interest be directed to or surround one or more objects of interest. For example, suppose a viewer of an experience sharing session of a deep-sea dive sees a particular fish and wishes to set the region of interest to surround the particular fish. Then, the viewer can instruct a wearable computing device and/or a server, such as server 122, to generate a region of interest that “snaps to” or exactly or nearly surrounds the particular fish. In some scenarios, the region of interest can stay snapped to the object(s) of interest while the objects move within the environment; e.g., continuing the previous example, the region of interest can move with the particular fish as long as the particular fish remains within the image(s) of the share.

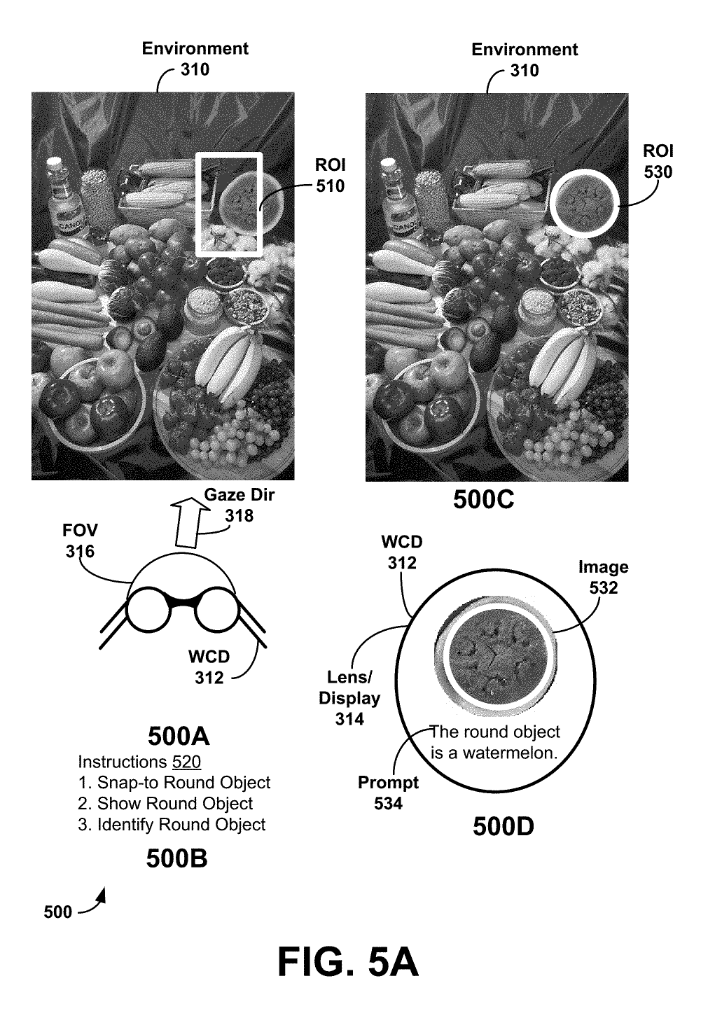

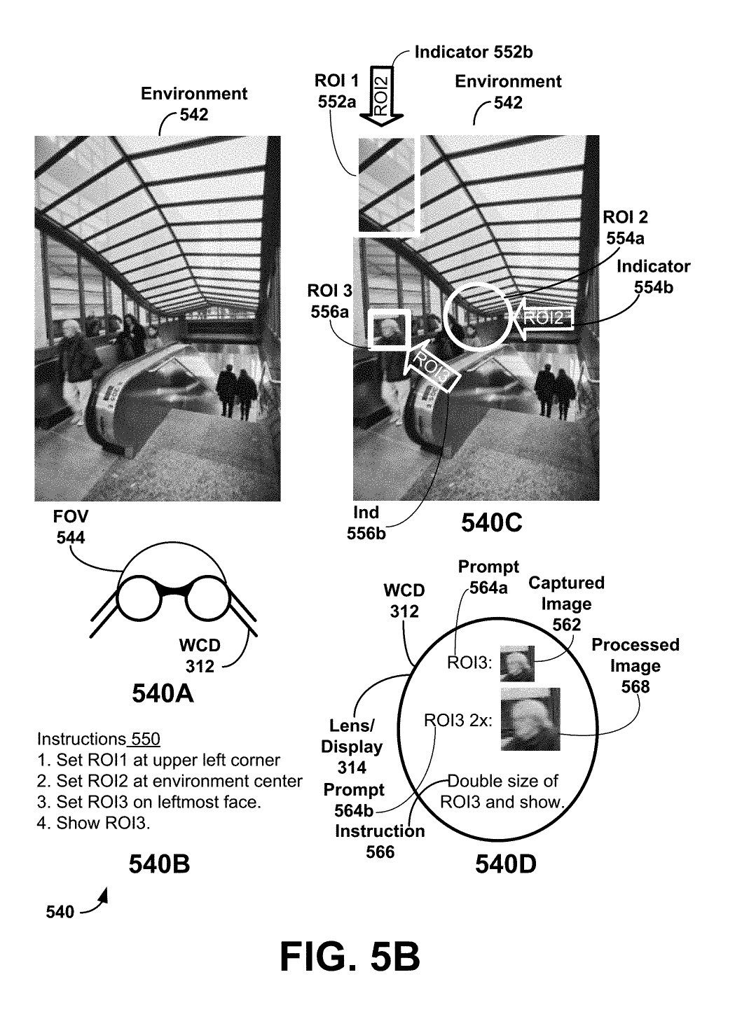

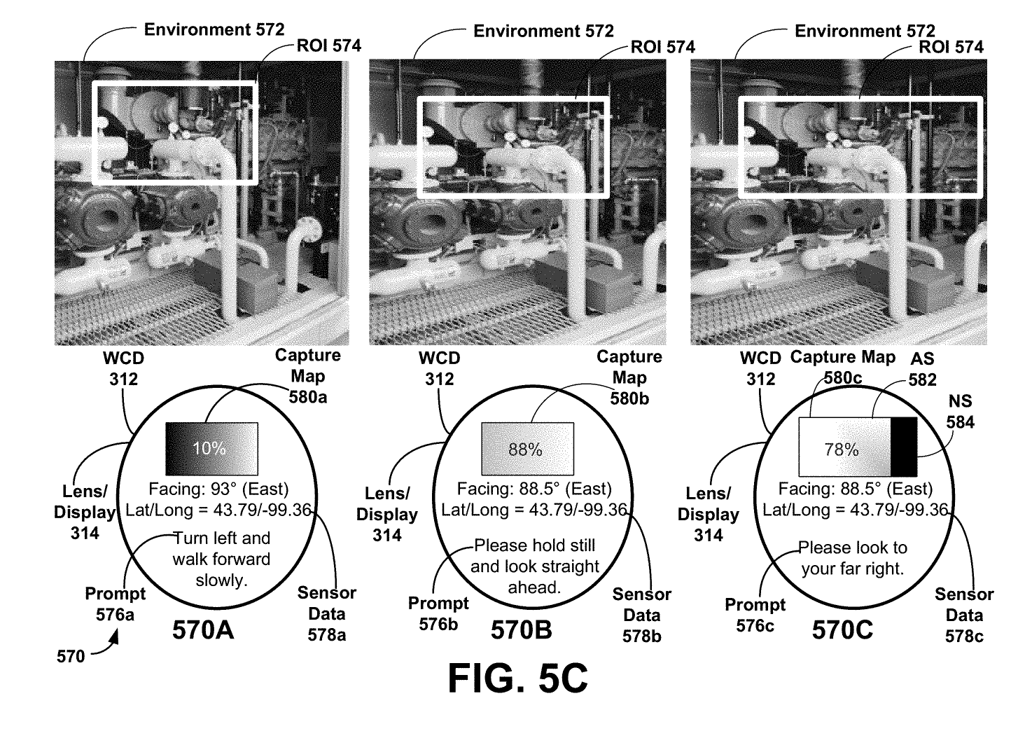

FIG. 5A shows a scenario 500 for snapping-to objects within a region of interest. At 500A of FIG. 5A, wearable computing device 312 having field of view 316 and gaze direction 318 has indicated region of interest 510 within environment 310.

At 500B of FIG. 5A, instructions 520 are provided to wearable computing device 312. FIG. 5A shows that instructions 520 include “1. Snap to Round Object”, “2. Show Round Object”, and “3. Identify Round Object”. The instructions can be provided to wearable computing device 312 using any and all of the techniques for providing input discussed above for instructions 410.

The snap-to instruction instructs the wearable computing device to reset the region of interest as specified by a user. For example, region of interest 510 includes portions of a basket of corn, a watermelon and a cotton plant. Upon receiving the “Snap-to Round Object” instruction of instructions 510, wearable computing device 312 can examine region of interest 510 for a “round object” and determine that the portion of the watermelon can be classified as a “round object.” FIG. 5A at 500C shows that, in response to the “Snap-to Round Object” instruction, wearable computing device 312 has reset the region of interest to round region of interest 530.

Supposing that wearable computing device 312 had not found a “round object” within region of interest 510, wearable computing device 312 can expand a search to include all of environment 310. Under this supposition, perhaps wearable computing device 312 would have found one or more of the tomatoes, bowls, grapes, apples, jar top, avocado portions, cabbage, and/or watermelon portion shown within environment 310 as the round objects.

After identifying the watermelon portion within region of interest 510 as the “round object”, wearable computing device 312 can execute the “Show Round Object” and “Identify Round Object” instructions of instructions 430. In response, as shown at 500D of FIG. 5A, wearable computing device 312 utilizes lens/display 314 to display image 532 and prompt 534.

To execute the “Show Round Object” command, wearable computing device 312 can capture an ROI image for region of interest 530, and display the ROI image as image 532 above prompt 438, as shown in FIG. 4B. In some embodiments, image 436 can be enlarged and/or otherwise enhanced when displayed on lens/display 314.

To execute the “Identify Round Object” command, wearable computing device 312 can generate queries for one or more search engines, search tools, databases, and/or other sources that include the ROI image. In some embodiments, additional information beyond the ROI image can be provided with the queries. Examples of additional information include contextual information about environment 310 such as time, location, etc. and/or identification information provided by the wearer of wearable computing device 312, such as a guess as to the identity of the “round object.” Upon generating these queries, wearable computing device 312 can communicate the queries as needed, and, in response, receive search results based on the queries. Then, wearable computing device 312 can determine the identity of the ROI image based on the search results. As shown in at 500D of FIG. 5A, wearable computing device 312 can provide prompt 534 identifying the round object as a watermelon.

FIG. 5B shows a scenario 540 for snapping-to arbitrary points and/or faces within a region of interest, in accordance with an example embodiment. At 540A of FIG. 5B, field of view 544 of wearable computing device 312 shows environment 542. As depicted in FIG. 5B, environment 542 is an entrance to a subway station with people both going into and leaving from the subway station.

At 540B of FIG. 5B, instructions 550 are provided to wearable computing device 312. FIG. 5B shows that instructions 550 include “1. Set ROI1 at upper left corner. 2. 1. Set ROI2 at environment center. 3. Set ROI3 on leftmost face. 4. Show ROI3.” The instructions can be provided to wearable computing device 312 using any and all of the techniques for providing input discussed above for instructions 410 and 510.

The set ROI instruction instructs the wearable computing device to set a region of interest defined by a point, perhaps arbitrarily defined, or object. For example, environment 542 is shown as a rectangular region with four corners and a center point. Upon receiving the “Set ROI1 at upper left corner” instruction of instructions 550, wearable computing device 312 can define a region of interest ROI1 whose upper-left-hand corner equals the upper-left-hand corner of environment 542. Similarly, if this instruction would have been “Set ROI1 at lower right corner” instruction, wearable computing device 312 can define a region of interest ROI1 whose lower-right-hand corner equals the lower-right-hand corner or environment 542.

In some embodiments, a region of interest can be provided to and/or defined on a server, such as the server hosting the experience sharing session. For example, the wearer can send region-of-interest information for a sequence of input images, the region-of-interest information can be information provided by the server, and/or region-of-interest information can be defined by a sharer interested in particular region of the sequence of input images. The region-of-interest information can be sent as metadata for the sequence of input images. For example, each region of interest can be specified as a set of pairs of Cartesian coordinates, where each pair of Cartesian coordinates corresponds to a vertex of a polygon that defines a region of interest within a given image of the sequence of input images. Then, as the input images and/or other information are sent from wearable computing device 312 to the server, the server can apply the region-of-interest information as needed. For example, suppose the images from the wearer are transmitted to the server as a sequence of full video frames and one or more wearer-defined regions of interest transmitted as metadata including pairs of Cartesian coordinates as discussed above. Then, the server can apply one or more wearer-defined regions of interest to the full video frames as needed.

The region-of-interest compressed video can then be sent to one or more viewers with relatively low bandwidth and/or to viewers who specifically request this compressed video, while other viewer(s) with a suitable amount of bandwidth can receive the sequence of full video frames. Server based region-of-interest calculations require less computing power for wearable computing devices with sufficient bandwidth and enable flexible delivery of video; e.g., both full video frames and region-of-interest compressed video, in comparison with only region-of-interest compressed video if the region-of-interest is applied using wearable computing device 312. In still other scenarios, full video frames can be sent to a viewer with suitable bandwidth along with region-of-interest information, perhaps sent as the metadata described above. Then, the viewer can use suitable viewing software to apply none, some, or all of the region-of-interest information in the metadata to the full video frames as desired.

In other scenarios not shown in FIG. 5B, a region of interest can be defined based on other arbitrary points than image centers or corners. For example, arbitrary points can be specified in terms of a unit of distance, such as pixels, inches/feet, meters, ems, points, and/or other units. That is, a region of interest can be defined using terms such as “Center ROI2 one inch above and ½ inch to the left of image center.” Sizes of the region of interest can be defined as well, perhaps using these units of distance; e.g., “Set ROI4 as a 5 cm×5 cm region of interest at lower left corner.” Further, a shape of the region of interest can be specified as well; e.g., “Set ROI5 as an oval, major axis 3 inches long, horizontal, minor axis 2 inches long, centered at image center.” Location, sizes, and shapes of regions of interest can be changed, in some embodiments, using a graphical user interface as well as using instructions as indicated herein. Many other examples and scenarios of specifying regions of interest of environment using arbitrary points, sizes, and shapes are possible as well.

The “Set ROI2 at image center” instruction of instructions 550 can instruct wearable computing device 312 can define a region of interest ROI2 that is centered at center of environment 542. As shown in FIG. 5B, ROI2 554a is shown using a circular region. In other scenarios, the shape(s) of region(s) of interest can vary from those depicted in FIG. 5B.

In embodiments where wearable computing device 312 can recognize one or more faces in an environment, an instruction such as “Set ROI3 on leftmost face” instruction of instructions 550 can instruct wearable computing device 312 to search an image of environment 542 for faces. At least three faces of people about to exit from an escalator can be recognized in environment 542. In some of these embodiments, facial detection and recognition can be “opt-in” features; i.e., wearable computing device 312 would report detection and/or recognition of faces of persons who have agreed to have their faces detected and/or recognized, and would not report detection and/or recognition of faces of persons who have not so agreed.

After recognizing the three faces, wearable computing device 312 can determine which face is the “leftmost” and set ROI3 to that portion of an image of environment 542. Then, in response to the “Show ROI3” instruction of instructions 540, wearable computing device 312 utilizes lens/display 314 to display captured image 562, corresponding to ROI3, and corresponding prompt 564a.

Upon viewing captured image 562, scenario 500 can continue by receiving additional instruction 564 to “Double size of ROI3 and show.” In response to instruction 564, wearable computing device 312 can display a double-sized processed image 566 and corresponding “ROI3 2×:” prompt 564b, as shown in FIG. 5B.

In some embodiments not shown in FIG. 5B, captured image 562 can be enhanced to sharpen image features as part of generating processed image 566, such as enhancing common facial features including jawlines, eyes, hair, and other facial features. Other image processing techniques can be used as well to enhance captured image 562 and/or processed image 566.

In other embodiments, facial and/or object detection within a sequence of image frames provided by wearable computing device 312 can be performed by a server, such as the server hosting the experience sharing session. The server can detect faces and/or objects of interest based on requests from one or more sharers and/or the wearer; e.g., the “Set ROI3 on leftmost face” instruction of instructions 550. Once the server has detected faces and/or objects of interest, the server can provide information about location(s) of detected face(s) and/or object(s) to wearable computing device 312 to the wearer and/or the one or more sharers.

In still other embodiments, both wearable computing device 312 and a server can cooperate to detect faces and/or objects. For example, wearable computing device 312 can detect faces and/or objects of interest to the wearer, while the server can detect other faces and/or images not specifically requested by the wearer; e.g., wearable computing device 312 performs the facial/object recognition processing requested by instructions such as instructions 550, and the server detects any other object(s) or face(s) requested by the one or more sharers. As the faces and/or objects are detected, wearable computing device 312 and the server can communicate with each other to provide information about detected faces and/or objects.

### Progressive Refinement of Captured Images

FIG. 5C shows a scenario 570 for progressive refinement of captured images, in accordance with an example embodiment. Scenario 570 involves capturing input images, using the captured input images to generate a processed image, and displaying the processed image. The images are captured over time, and combined to progressively refine the processed image. Feedback is provided to a wearer, via a prompt and a capture map, to gather the input images.

The resolution of an image, perhaps corresponding to a region of interest, can be increased based on a collection of images. The received collection of images can be treated as a panorama of images of the region of interest. As additional input images are received for the region of interest, images of overlapping sub-regions can be captured several times.

Overlapping images can be used to generate a refined or “processed” image of the region of interest. A super-resolution algorithm can generate the processed image from an initial image using information in the overlapping images. A difference image, as well as differences in position and rotation, between an input image of the overlapping images and the initial image is determined. The difference image can be mapped into a pixel space of the initial image after adjusting for the differences in position and rotation. Then, the processed image can be generated by combining the adjusted difference image and the initial image. To further refine the processed image, the super-resolution algorithm can utilize a previously-generated processed image as the initial image to be combined with an additional, perhaps later-captured, input image to generate a new processed image. Thus, the initial image is progressively refined by the super-resolution algorithm to generate a (final) processed image.

Also, features can be identified in the overlapping images to generate a “panoramic” or wide-viewed image. For example, suppose two example images are taken: image1 and image2. Each of image1 and image2 are images of separate six-meter wide by four-meter high areas, where the widths of the two images overlap by one meter. Then, image1 can be combined with image2 to generate an panoramic image of a eleven-meter wide by four-meter high area by either (i) aligning images image1 and image2 and then combining the aligned images using an average or median of the pixel data from each images or (ii) each region in the panoramic image can be taken from only one of images image1 or image2. Other techniques for generating panoramic and/or processed images can be used as well or instead.

Once generated, each processed image can be sent to one or more sharers of an experience sharing session. In some cases, input and/or processed images can be combined as a collection of still images and/or as a video. As such, a relatively high resolution collection of images and/or video can be generated using the captured input images.

Scenario 570 begins at 570A with wearable computing device 312 worn by a wearer during an experience sharing session involving environment 572, which a natural gas pump at a bus depot. A region of interest 574 of environment 572 has been identified on a portion of the natural gas pump. Region of interest 574 can be identified by the wearer and/or by one or more sharers of the experience sharing session. In scenario 570, wearable computing device 312 is configured to capture images from a point of view of the wearer using at least one forward-facing camera.

FIG. 5C at 570A shows wearable computing device 312 displaying prompt 576a, sensor data 578a, and capture map 580a on lens/display 314. Prompt 576a can provide information and instructions to the wearer to gather additional input images for generating processed images. Sensor data 578a provides directional information, such as a “facing” direction and a location in latitude/longitude coordinates. In some embodiments, sensor data, such as sensor data 578a, can be provided to a server or other devices to aid generation of processed images. For example, the facing direction and/or location for an image can be used as input(s) to the above-mentioned super-resolution algorithm.

In scenario 570, the wearer for the experience sharing session captures input images for generating processed images of region of interest 574, but does not have access to the processed images. At 570A, prompt 576a and/or capture map 580a can provide feedback to the wearer to ensure suitable input images are captured to for processed image generation. Prompt 576a, shown in FIG. 5C as “Turn left and walk forward slowly” can inform the wearer how to move to capture images used to generate the processed image.

Capture map 580a can depict region of interest 574 and show where image(s) need to be captured. As shown at 570 FIG. 5C, capture map 580a indicates a percentage of image data collected of 10%. Capture map 580a is darker on its left side than on its right side, indicating that more image(s) need to be collected for the left side of region of interest 574 than on the right side.

The herein-described prompts, capture maps, and/or processed images can be generated locally, e.g., using wearable computing device 312, and/or remotely. For remote processing, the input images and/or sensor data can be sent from wearable computing device 312 to a server, such as the server hosting the experience sharing session. The server can generate the prompts, capture map, and/or processed images based on the input images, and transmit some or all of these generated items to wearable computing device 312.

Scenario 570 continues with the wearer turning left and walking forward, while images are captured along the way. At 570B of FIG. 5C, prompt 576b instructs the wearer to “hold still and look straight ahead” to capture additional images. Capture map 580b shows that additional image data has been captured via the image data collected percentage of 88%. Capture map 580b uses lighter coloration to indicate more data has been collected than at a time when capture map 580a was generated. FIG. 5C shows that that capture map 580b is still somewhat darker on the left side than on the right, indicating that additional data from the left side of region of interest 574 is needed.

Scenario 570 continues with region of interest 574 being extended to the right by a right extension area, as shown at 570C of FIG. 5C. FIG. 5C shows that prompt 576c guides the wearer to “look to your far right.” Capture map 580c shows more additional image data is required via the image data collected percentage of 78%, which is down from the 88% shown at 570B. Capture map 580c also shows that sufficient data for the left side of region of interest 574 has been captured via a white sub-region on the left side of capture map 580c. Capture map 580c includes a no-data section (NS) 584. No-data section 584, shown as a black sub-region of the right side of capture map 580c, informs the wearer that no data has been captured in the right extension area. Capture map 580c uses white coloration on its left side to indicating that sufficient image data has been collected for the left side of region of interest 574.

FIG. 5C shows aged section (AS) 582 in a central portion of capture map 580c as slightly darker than the left side of capture map 580c. To ensure processed images of region of interest 574 are based on current image data, each input image can be associated with a time of capture, and thus an age of the input image can be determined. When the age of the input image exceeds a threshold time, the input image can be considered to be partially or completely out of date, and thus partially or completely insufficient. In scenario 570, aged section 582 informs the wearer that data may need to be recaptured due to partially insufficient input image(s) in the central portion of region of interest 574. In response, the wearer can capture image data in the central portion to replace partially insufficient input image(s). Once replacement input image(s) is/are captured and the partially insufficient image data has been updated, aged section 582 can be updated to display a lighter color, informing the wearer that captures of the central portion of region of interest 574 are not currently required.

### Gaze Direction

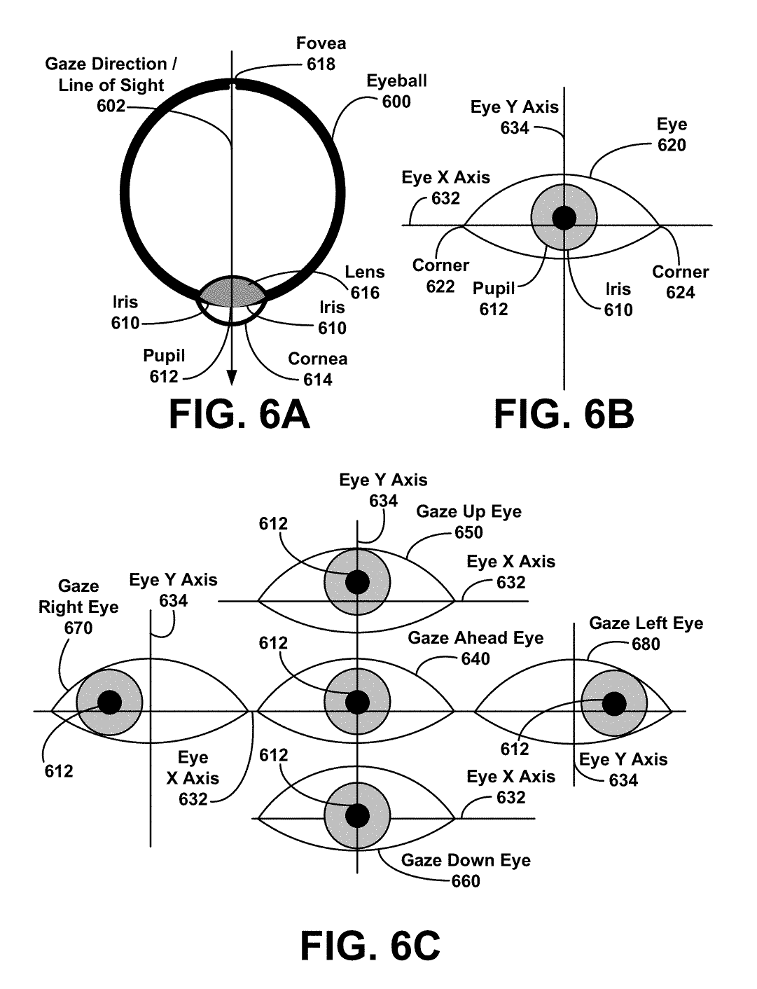

FIGS. 6A-6C relate to tracking gaze directions of human eyes. The gaze direction, or direction that the eyes are looking, can be used to implicitly specify a region of interest. For example, the region of interest can be specified based on the gaze direction of a wearer of a wearable computing device.

FIGS. 6A and 6B are schematic diagrams of a human eye. FIG. 6A shows a cutaway view of eyeball 600 with iris 610, pupil 612, cornea 614, and lens 616 at the front of eye 600 and fovea 618 at the back of eye 600. Light first reaches cornea 614, which protects the front of eye 600, and enters eye 600 via pupil 612. Light then travels through eye 600 to reach fovea 618 to stimulate an optic nerve (not shown) behind fovea 618 and thus indicate that light is present at eye 600. Eye 600 has a gaze direction, or point of view, 602 from fovea 618 through pupil 612.

FIG. 6B shows eye 620, which is a portion of eyeball 600 typically visible in a living human. FIG. 6B shows that iris 610 surrounds pupil 612. Pupil 612 can expand in low-light situations to permit more light to reach fovea 618 and can contract in bright-light situations to limit the amount of light that reaches fovea 618. FIG. 6B also shows “eye X axis” 632 that traverses corners 622 and 624 of eye 620 and “eye Y axis” 634 that traverse the center of eye 620.

FIG. 6C shows examples of eye 620 looking in various directions, including gaze ahead eye 640, gaze up eye 650, gaze down eye 660, gaze right eye 670, and gaze left eye 680. Gaze ahead eye 640 shows eye 620 when looking directly ahead. The bottom of pupil 612 for gaze ahead eye 640 is slightly below eye X axis 632 and is centered along eye Y axis 634.

Gaze up eye 650 shows eye 620 when looking directly upwards. The bottom of pupil 612 for gaze up eye 650 is well above eye X axis 632 and again is centered along eye Y axis 634. Gaze down eye 660 shows eye 620 when looking directly downward. Pupil 612 for gaze down eye 650 is centered slightly above eye X axis 632 and centered on eye Y axis 634.

Gaze right eye 670 shows eye 620 when looking to the right. FIG. 6C shows gaze right eye 670 with the bottom of pupil 612 slightly below eye X axis 632 and to the left of eye Y axis 634. Gaze right eye 670 is shown in FIG. 6C with pupil 612 to the left of eye Y axis 634 as gaze direction 602 from fovea 618 to pupil 612 in gaze right eye 670 is directed to the right of fovea 618, and thus is “gazing right” from the point of view of fovea 618, and also of a person with eye 620. That is, an image of eye 620 taken as a person with eye 620 who is asked to look right before capturing the image will show pupil 612 to the left of eye Y axis 634.

Gaze left eye 680 shows eye 620 when looking to the left. FIG. 6C shows gaze left eye 680 with the bottom of pupil 612 slightly below eye X axis 632 and to the right of eye Y axis 634. Gaze left eye 680 is shown in FIG. 6C with pupil 612 to the right of eye Y axis 634 as gaze direction 602 is directed to the left of fovea 618, and thus is gazing left, from the point of view of fovea 618 and also of a person with eye 620. That is, an image of eye 620 taken as a person with eye 620 who is asked to look left before capturing the image will show pupil 612 to the right of eye Y axis 634.

Gaze direction 602 of eye 620 can be determined based on the position of pupil 612 with respect to eye X axis 632 and eye Y axis 634. For example, if pupil 612 is slightly above eye X axis 632 and centered along eye Y axis 634, eye 620 is gazing straight ahead, as shown by gaze ahead eye 640 of FIG. 6C. Gaze direction 602 would have an upward (+Y) component if pupil 612 were to travel further above eye X axis 632 than indicated by gaze ahead eye 640, and would have downward component (−Y) if pupil 612 were to travel further below eye X axis 632 than indicated for gaze ahead eye 640.

Similarly, gaze direction 602 would have a rightward (+X) component if pupil 612 were to travel further to the left of eye Y axis 634 than indicated by gaze ahead eye 640, and would have a leftward (−X) component if pupil 612 were to travel further to the right of eye Y axis 634 than indicated by gaze ahead eye 640.

### Exemplary Eye-Tracking Functionality

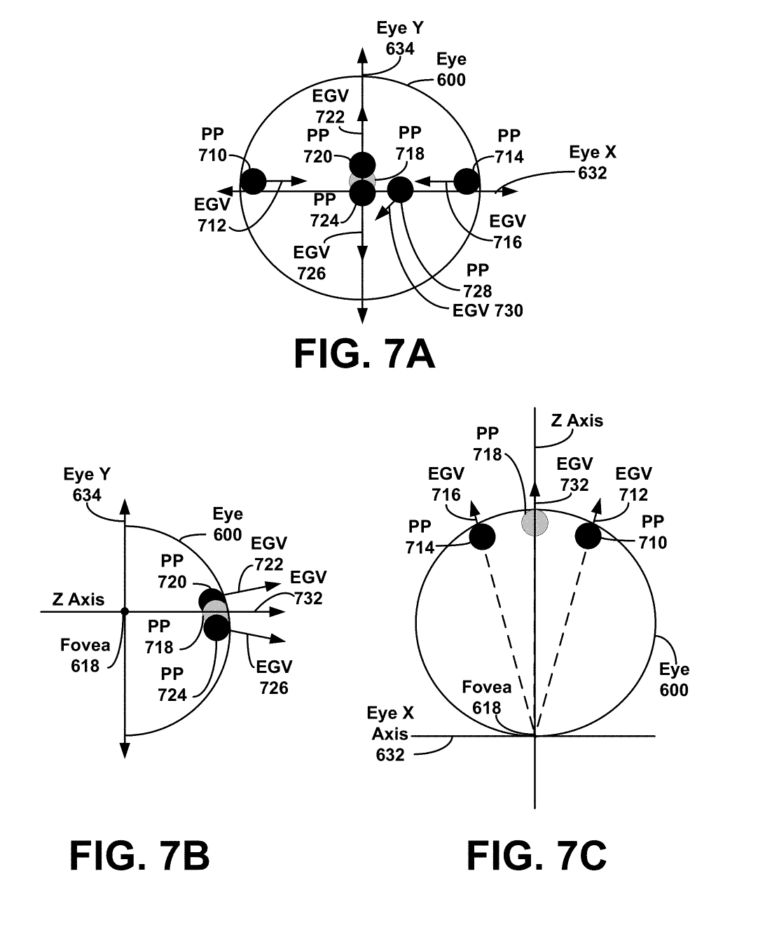

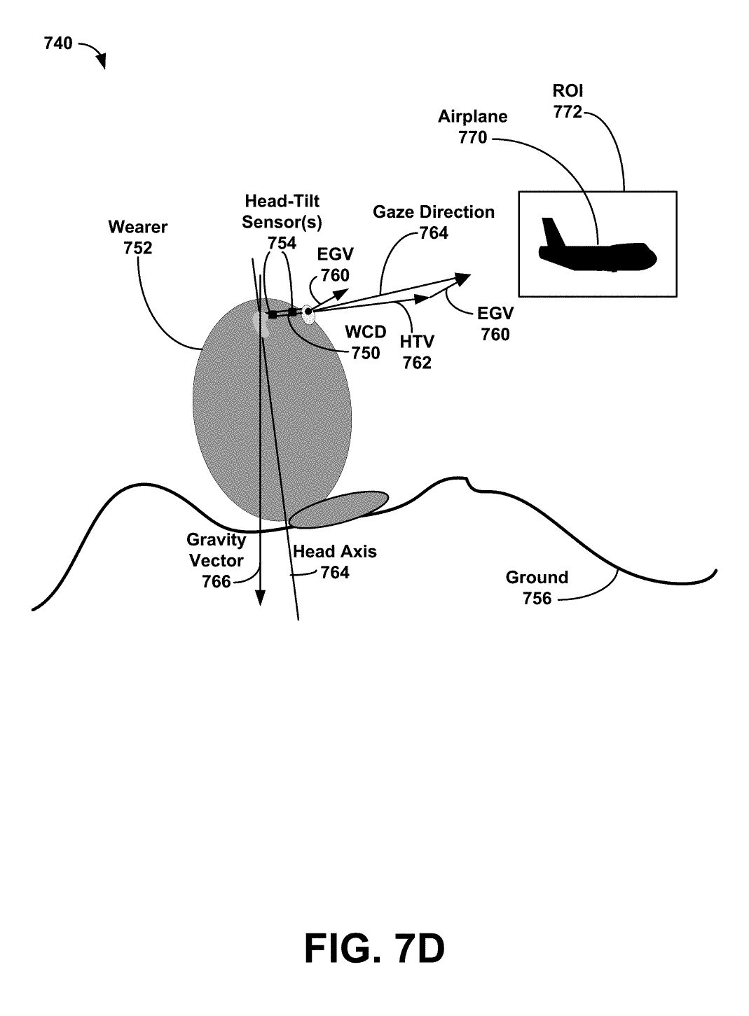

FIGS. 7A-7C gaze vectors, which are vectors in the gaze direction of eyes that may take into account a tilt of the human's head. The gaze vectors can be used, similarly to gaze directions, to implicitly specify a region of interest. For example, the region of interest can be specified based along the gaze vector of a wearer of a wearable computing device.

FIG. 7A shows eye gaze vectors (EGVs) when pupil 612 of eye 600 (or eye 620) is in six pupil positions (PPs) in the eye X axis 632/eye Y axis 634 plane. At pupil position 710, which corresponds to a position of pupil 612 in gaze right eye 670, eye gaze vector 712 is shown pointing in the positive eye X axis 632 (rightward) direction with a zero eye Y axis 634 component. At pupil position 714, which corresponds to a position of pupil 612 in gaze left eye 680, eye gaze vector 712 is shown pointing in the negative eye X axis 632 (leftward) direction with a zero eye Y axis 634 component.

At pupil position 718 (shown in grey for clarity in FIGS. 7A-7C), which corresponds to a position of pupil 612 in gaze ahead eye 640, no eye gaze vector is shown in FIG. 7A as the eye gaze vector at pupil position 718 has zero components in both in the eye X axis 632 and the eye Y axis 634.

At pupil position 720, which corresponds to a position of pupil 612 in gaze up eye 650, eye gaze vector 722 is shown pointing in the positive eye Y axis 634 (upward) direction with a zero eye X axis 632 component. At pupil position 724, which corresponds to a position of pupil 612 in gaze down eye 660, eye gaze vector 726 is shown pointing in the negative eye Y axis 634 (upward) direction with a zero eye X axis 632 component.

As shown in FIG. 7A, pupil position 728 is a position of pupil 612 when eye 600 is looking down and to the left. Corresponding eye gaze vector 730 is shown in FIG. 7A with a negative eye X axis 622 component and a negative eye Y axis 624 component.

FIG. 7B shows pupil positions in the eye Y axis 634/Z plane. Fovea 618 is assumed to be at point (0, 0, 0) with positions toward a visible surface of eye 600 having +Z values. At pupil position 718, corresponding to gaze ahead eye 640, eye gaze vector 732 has a zero eye Y axis 634 component and a positive (outward) Z axis component. Thus, eye gaze vector 732 is (0, 0, Z_{ahead}), where Z_{ahead} is the value of the Z axis component for this vector. At pupil position 720, corresponding to gaze up eye 640, eye gaze vector 722 has both positive eye Y axis 634 and Z axis components. Thus, eye gaze vector 722 is (0, Yᵤₚ, Zᵤₚ), where Yᵤₚ and Zᵤₚ are the values of the respective eye Y axis 634 and Z axis components for this eye gaze vector, with Yᵤₚ>0 and Zᵤₚ>0. At pupil position 724, corresponding to gaze down eye 650, eye gaze vector 726 has a negative eye Y axis 634 component and a positive Z axis component. Thus, eye gaze vector 726 is (0, Y_{down}, Z_{down}), where Y_{down} and Z_{down} are the values of the respective eye Y axis 634 and Z axis components for this eye gaze vector, with Y_{down}<0 and Z_{down}>0.

FIG. 7C shows pupil positions in the eye X axis 632/Z plane. As with FIG. 7B, fovea 618 is assumed to be at point (0, 0, 0) with positions toward the visible surface of eye 600 having +Z values. FIG. 7C shows pupil positions 710 and 714 from the point of view of fovea 618. The pupil positions are thus shown as reversed along eye X axis 632 in comparison to FIG. 7A.

At pupil position 718, corresponding to gaze ahead eye 620, eye gaze vector 732 has a zero eye Y axis 634 component and a positive (outward) Z axis component. As mentioned above, eye gaze vector 732 is (0, 0, Z_{ahead}), where Z_{ahead} is the value of the Z axis component for this vector. At pupil position 714, corresponding to gaze left eye 680, eye gaze vector 716 has a negative eye X axis 632 component and a positive Z axis component. Thus, eye gaze vector 716 will be (X_{left}, 0, Z_{left}), where X_{left} and Z_{left} are the values of the respective eye X axis 632 and Z axis components for this eye gaze vector, with X_{left}<0 and Z_{left}>0. At pupil position 710, corresponding to gaze right eye 670, eye gaze vector 712 has both positive eye X axis 632 and Z axis components. Thus, eye gaze vector 712 will be (X_{right}, 0, Z_{right}), where X_{right} and Z_{right} are values of the respective eye X axis 632 and Z axis components for this eye gaze vector, with X_{right}>0 and Z_{right}>0. A basis can be generated for transforming an arbitrary pupil position (Px, Py) into an eye gaze vector (X, Y, Z), such as by orthogonalizing some or all eye gaze vectors 712, 716, 722, 726, and 732, where Px and Py are specified in terms of eye X axis 632 and eye Y axis 634, respectively.

Then, wearable computing device 312 can receive an image of a picture of an eye of a wearer of wearable computing device 312, determine a pupil position (Px, Py) specified in terms of eye X axis 632 and eye Y axis 634 by analyzing the image by comparing the pupil position to pupil positions of gazing eyes 640, 650, 660, 670, and 680, and use the basis to transform the (Px, Py) values into a corresponding eye gaze vector. In some embodiments, wearable computing device 312 can send the image of the eye(s) of the wearer to a server, such as server 122, for the server to determine the eye gaze vector based on received images of the eye(s) of the wearer.

An eye gaze vector can be combined a head-tilt vector to determine a gaze direction and perhaps locate a region of interest in an environment. FIG. 7D shows a scenario 740 for determining gaze direction 764, in accordance with an embodiment. In scenario 740, wearer 752 is walking along ground 756 wearing wearable computing device 750 configured with head-tilt sensor(s) 754.

Head-tilt sensor(s) 754 can be configured to determine a head-tilt vector of a head of wearer 752 corresponding to a vector perpendicular to head axis 764. Head axis 764 is a vector from a top to a base of the head of wearer 752 running through the center of the head of wearer 752. Head tilt vector 762 is a vector perpendicular to head axis 764 that is oriented in the direction of a face of the viewer (e.g., looking outward). In some embodiments, the head axis 764 and head tilt vector through a fovea of an eye of wearer 752, or some other location within the head of wearer 752.

One technique is to use one or more accelerometers as head-tilt sensor(s) 754 to determine head axis 764 relative to gravity vector 766. Head tilt vector 762 can be determined by taking a cross product of head axis 764 and the (0, 0, +1) vector, assuming the +Z direction is defined to be looking outward in the determination of head axis 764. Other methods for determining head tilt vector 762 are possible as well. Eye gaze vector 760 can be determined using the techniques discussed above or using other techniques as suitable. Gaze direction 764 can then be determined by performing vector addition of head tilt vector 762 and eye gaze vector 760. In other embodiments, data from head-tilt sensor(s) 754 and/or other data can be sent to a server, such as server 122, to determine head tilt vector 762. In particular embodiments, the server can determine eye gaze vectors, such as eye gaze vector 760, as mentioned above and thus determine gaze direction 764.

Eye gaze vector 760, head tilt vector 762, and/or gaze direction 764 can then be used to locate features in images of an environment in the direction(s) of these vectors and determine an appropriate region of interest. In scenario 740, gaze direction 764 indicates wearer 752 may be observing airplane 770. Thus, a region of interest 772 surrounding airplane 770 can be indicated using eye gaze vector 760 and/or gaze direction 764 and images of an environment. If the images are taken from a point of view of wearer 752, eye gaze vector 760 specifies a line of sight within the images. Then, wearable computing device 312 and/or a server, such as server 122, can indicate region(s) of interest that surround object(s) along the line of sight.

If images of the environment are taken from a different point of view than the point of view of wearer 752, gaze direction 764 can be used to determine a line of sight within the images, perhaps by projecting gaze direction 764 along a vector specifying the point of view of the images. Then, wearable computing device 312 and/or a server, such as server 122, can indicate region(s) of interest that surround object(s) along the line of sight specified by the projection of gaze direction 764.

Note that the description herein discusses the use of pupil positions, or the position of a pupil of an eye, to determine eye gaze vectors. In some embodiments, pupil positions can be replaced with iris positions, or the position of an iris of the eye, to determine eye gaze vectors.

Moreover, it should be understood that while several eye-tracking techniques are described for illustrative purposes, the type of eye-tracking technique employed should not be construed as limiting. Generally, any eye-tracking technique that is now known or later developed may be employed to partially or completely determine a region of interest, without departing from the scope of the invention.

### Auditory Regions of Interest

The above examples have generally dealt with specifying a visual region of interest. However, some embodiment may additionally or alternatively involve auditory regions of interest (e.g., what a user is listening to).

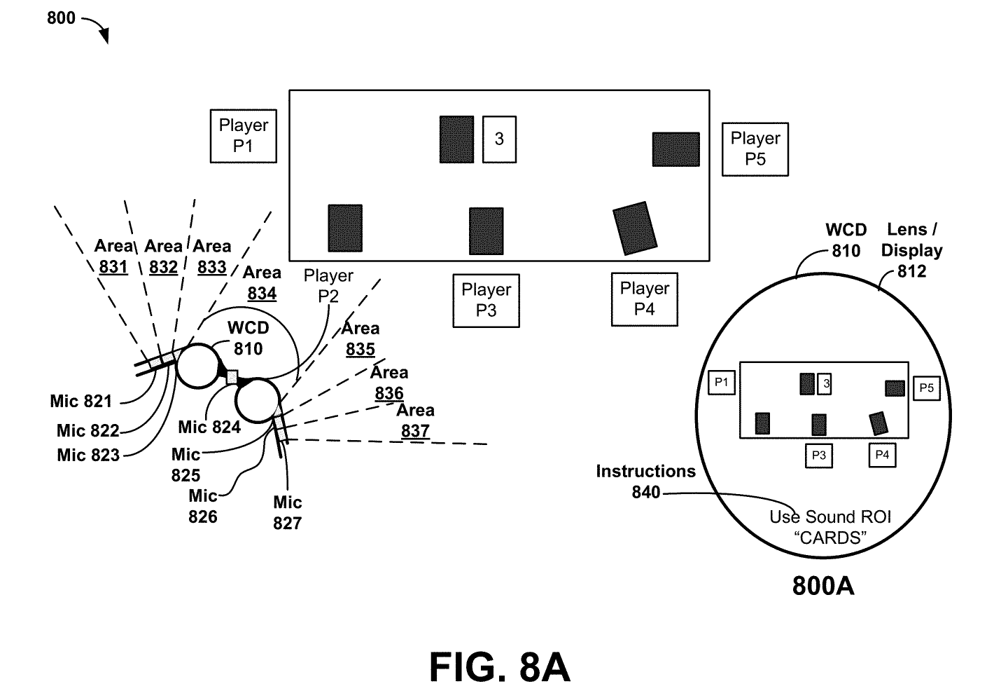

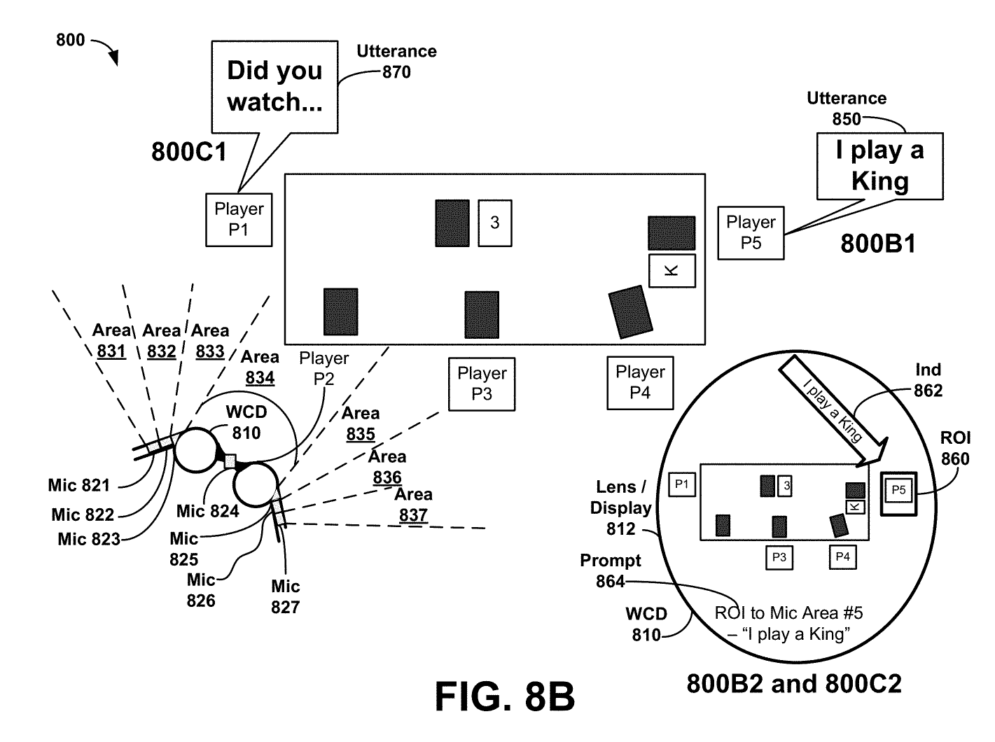

FIGS. 8A and 8B describe a scenario 800 where sounds are used to determine regions of interest. Sounds and terms of interest can be specified using a sound-based region-of interest (ROI) file. During operation, a wearable computing device associated with one or more microphones or similar sound-detection devices observes sounds in the environment. A wearer of the wearable computing device can specify use of a sound-based-ROI file to specify sound-based ROIs. If an observed sound matches a sound or term of interest in the sound-based-ROI file, then a sound-based region of interest can be designated that corresponds to an area where the observed sound was generated or uttered. The area can in turn be related to a microphone of the one or more microphones that picks up the observed sound.

FIGS. 8A and 8B depict a scenario 800 where sounds determine regions of interest and corresponding indicators, in accordance with an embodiment. As shown at 800A of FIG. 8A, a game of cards is being played with five players, players P1 through P5, with player P2 wearing wearable computing device 810. An example of wearable computing device 810 is wearable computing device 312 equipped with one or more microphones.

At 800A of FIG. 8A, wearable computing device 810 is equipped with seven microphones (the “Mic”s shown in FIG. 8A) 821-827. Each of microphones 821-827 can best detect sounds in an associated area of space. For example, FIG. 8A indicates that microphone 821 can best detect sounds in area 831, which is delimited by dashed lines. Similarly, FIG. 8A indicates that microphone 822 can best detect sounds in area 832; microphone 823 can best detect sounds in area 833, and so on. In some embodiments, some or all of microphones 821-827 are directional microphones. Each of areas 831-837 is assumed to extend from the microphone outward as far as the microphone can detect sounds, which may be farther from or closer to wearable computing device 810 than shown using the dashed lines of FIG. 8A.

At 800A of FIG. 8A, player P2 provides instructions 840 to wearable computing device 810. FIG. 8A shows that instructions 840 include “Use Sound ROI ‘CARDS’” and are displayed on lens/display 812 of wearable computing device 810. The “Use Sound ROI” instruction instructs wearable computing device 810 to use sounds to specify a region of interest (ROI). In some embodiments, a region of interest can be indicated using indicators as well.

Specifying the term “CARDS” as part of the Use Sound ROI instruction, further instructs wearable computing device 810 to specify a sound-based region of interest only after detecting terms related to “CARDS”; that is, sounds are to be screened for terms related to terms found in a sound-based-ROI file or other storage medium accessible by wearable computing device 810 using the name “CARDS.” Example terms in a sound-based-ROI file for “CARDS” could include standard terms used for cards (e.g., “Ace”, “King”, “Queen”, “Jack”) various numbers, and/or card-related jargon (e.g., “hand”, “pair”, “trick”, “face cards”, etc.). As another example, sound-based-ROI for patents can include standard terms (e.g., “patent”, “claim”, “specification”), various numbers, and/or jargon (e.g., “file wrapper”, “estoppel”, “102 rejection”, etc.) Many other examples of terminology can be provided in the sound-based-ROI file to specify a sound-based region of interest are possible as well. In other scenarios, various sounds can be used instead or along with terms in the sound-based-ROI file; for example, the sound of gears grinding may be added to a sound-based-ROI file as part of terminology and sounds related to auto repair.

Scenario 800 continues at 800B1 of FIG. 8B, where player P5 makes utterance 850 “I play a King.” FIG. 8B shows that player P5 is in area 835. Then, upon detecting utterance 850 with microphone 825, wearable computing device 810 can determine that utterance 850 includes a card term “King” and consequently set region of interest within area 835. That is, utterance 850 that includes an utterance of interest, e.g., the word “King”, that can be used, along with the sound-based-ROI file “CARDS”, to indirectly specify a region of interest. FIG. 8A at 800B2 shows that wearable computing device 810 indicates region of interest 860 as a black rectangle surrounding an image of player P5 shown in lens/display 812.

In some embodiments, wearable computing device 810 includes a speech-to-text module, which can be used to convert utterance 850 to text. FIG. 8B shows that the text of “I play a King” of utterance 850 is shown within an arrow used as indicator 862, which is near the image of player P5 shown in lens/display 812. In other embodiments, indicator 862 does not include text; for example, an arrow or other graphical object without text can be used as indicator 862. Both region of interest 860 and indicator 862 are both displayed by wearable computing device 810 in response to utterance 850 matching one or more card terms, as previously instructed by player P2.

Scenario 800 continues at 800C1 of FIG. 8B, where player P1 utters utterance 870 of “Did you watch . . . ’ In scenario 800, microphone 822 detects utterance 870. Wearable computing device 810 can determine that no card terms are used in utterance 870, and therefore determine that region of interest 860 and indicator 862 should remain based on utterance 850, as depicted at 800C2 of FIG. 8B.

In other scenarios not shown in FIG. 8B, utterance 870 does include one or more card terms. In these scenarios, wearable computing device 810 can change the region of interest and/or indicator based on utterance 870 and/or display multiple regions of interest and/or indicators; e.g., display a number 1 at or near region of interest 860 and/or indicator 862 to indicate sounds related to region of interest 860 and/or indicator 862 occurred first, display a number 2 at or near a region of interest and/or an indicator related to utterance 870 to indicate sounds related to utterance 870 occurred second, and so on. In even other scenarios, player P2 can instruct wearable computing device 810 to ignore some areas and/or speakers of utterances; for example, if player P1 is not playing in the current game of cards and/or is often ignored by player P2, player P2 can instruct wearable computing device 810 to ignore utterances from player P1.

In still other scenarios, a user of wearable computing device 810 can inhibit display of regions of interest and/or indicators from one or more areas or microphones. For example, suppose the user of wearable computing device 810 is attending a play where the user is unfamiliar with the terminology that might be used or does not want to screen the play based on terminology. Further suppose, the user does not want to have regions of interest and/or indicators appear on wearable computing device 810 based on sounds from the audience.

Then, the user of wearable computing device 810 can inhibit wearable computing device 810 from providing regions of interest and/or indicators from microphone(s) and/or area(s) corresponding to microphone(s) most likely to detect sounds from audience members and/or within areas mostly or completely containing audience members. Thus, the user of wearable computing device 810 can use regions of interest and/or indicators to track the sounds primarily made by the cast of the play, and perhaps aid following the plot to enhance the user's enjoyment of the play.

In other embodiments, audio from the microphones 821-827 can be captured and stored. The captured audio can be then transmitted in portions, perhaps corresponding to audio portions as captured by one of microphones 821-827; e.g., a transmitted portion that includes sounds detected by microphone 821, a next portion that includes sounds detected by microphone 822, a third portion that includes sounds detected by microphone 823, and so on. In some embodiments, an “interesting” portion of the captured audio can be transmitted in a first audio format and an “uninteresting” portion of the captured audio can be transmitted in a second audio format. In these embodiments, the interesting portion can correspond to audio of interest or an audio region of interest, such area 835 in scenario 800 discussed above. In scenario 800, the interesting portion may then include sounds detected by microphone 814 and the first audio format can provides a higher audio volume or fidelity than the second audio format used for the uninteresting portion, such as sounds detected by microphone 827 in scenario 800 discussed above.

In still other embodiments, wearable computing device 810 can compress different audio sources based on expected or actual content. For example, the microphone near the wearer's mouth can be associated with and/or use a compression algorithm designed for speech, while an external microphone may use a compression algorithm designed for music or other sounds.

As another example, wearable computing device 810 can test compression algorithms on a sample and utilize the best algorithm based on performance of the sample. That is, wearable computing device 810 receive a sample of audio from a microphone, compress the sample using two or more compression algorithms, and use the compression algorithm that best performs on the sample for subsequent audio received from the microphone. The wearable computing device 810 can then choose another sample for compression testing and use, either as requested by a wearer of wearable computing device 810, upon power up and subsequent reception of audio signals, after a pre-determined amount of time, after a pre-determined period of silence subsequent to sampling, and/or based on other conditions.

Additionally, direct specification of a sound-based region of interest can be performed. In the example shown in FIG. 8B, player P2 can provide instructions to wearable computing device 810 to “Set ROI to Area 835” or equivalently, “Set ROI Device to Mic 825” to explicitly specify which area(s) or microphone(s) associated with wearable computing device 810 are used to specify sound-based region(s) of interest.

### Exemplary Methods

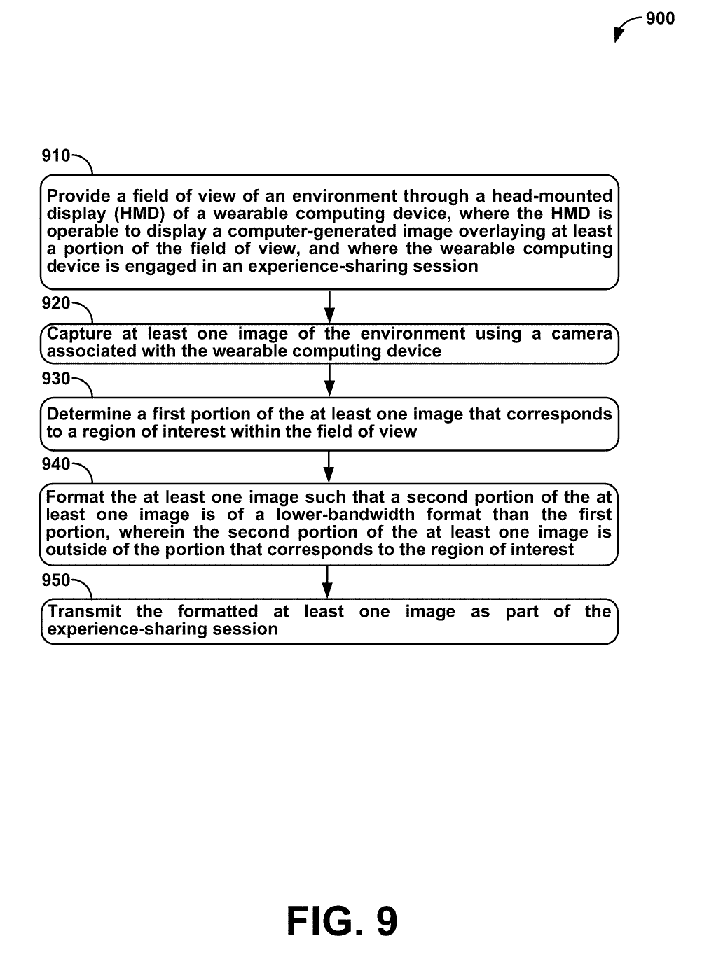

Example methods 900, 1000, and 1100 related to regions of interest are disclosed below. FIG. 9 is a flowchart of a method 900, in accordance with an example embodiment.

At block 910, a field of view of an environment is provided through a head-mounted display (HMD) of a wearable computing device. The HMD is operable to display a computer-generated image overlaying at least a portion of the view. The wearable computing device is engaged in an experience sharing session. Views of environments provided by wearable computing devices are discussed above at least in the context of FIGS. 3A-5, 8A, and 8B.

In some embodiments, the experience sharing session can include an experience sharing session with the wearable computing device and at least a second computing device, such as discussed above at least in the context of FIGS. 3A-5. In particular of these embodiments, the wearable computing device can receiving the indication of the region of interest from the wearable computing device, while in other particular of these embodiments, the wearable computing device can receiving the indication of the region of interest from the second computing device.

At block 920, at least one image of the real-world environment is captured using a camera on the wearable computing device. Capturing images of the environment is discussed above at least in the context of FIGS. 3A-5, 8A, and 8B.

In other embodiments, the camera is configured to move with the HMD, such as discussed above at least in the context of FIGS. 3A-5.

In still other embodiments, the camera is configured to be controlled via the wearable computing device, such as discussed above at least in the context of FIGS. 3A-5.

At block 930, the wearable computing device determines a first portion of the at least one image that corresponds to a region of interest within the field of view. Determining regions of interest are discussed above in the context of at least in the context of FIGS. 4A-5 and 7A-8B.

In some embodiments, determining the first portion of the at least one image that corresponds to the region of interest can include receiving an indication of the region of interest from a wearer of the wearable computing device, such as discussed above at least in the context of FIGS. 4A-11 and 7A-14B.

In particular of these embodiments, defining the region of interest can be based, at least in part, on an eye movement of the wearer, such as discussed above in the context of FIGS. 7A-C. In some of these particular embodiments, defining the region of interest can include determining an eye gaze vector for the wearer and defining the region of interest based, at least in part, on the eye gaze vector, such as discussed above at least in the context of FIG. 7D.

In other of these particular embodiments, defining the region of interest can include determining a head tilt vector, determining a gaze direction based on the eye gaze vector and the head tilt vector; and determining the region of interest based on the gaze direction.

In still other of these particular embodiments, the wearable computing device can include a photodetector. Then, defining the region of interest can include: determining a location of an iris of an eye of the wearer using the photodetector and determining the eye gaze vector based on the location of the iris of the eye, such as discussed above at least in the context of FIGS. 2A-2E.

In still other embodiments, such as discussed above at least in the context of FIGS. 4A-5 and 7A-8B, the region of interest includes an object in the real-world environment. In particular of these still other embodiments, such as discussed above at least in the context of FIGS. 4A-5 and 7A-8B, displaying, on the HMD, the indication of the region of interest includes displaying an image that indicates the object, while in other particular of these still other embodiments such as discussed above at least in the context of FIGS. 4A-5 and 7A-8B, displaying, on the HMD, the indication of the region of interest includes displaying text that indicates the object.

In some embodiments, such as discussed above at least in the context of FIG. 4C, the transmitted video is received by a remote viewer. In particular of these embodiments, such as discussed above at least in the context of FIG. 4C, the indication of the region of interest is received from the remote viewer.

At block 940, formatting the at least one image such that a second portion of the at least one image is of a lower-bandwidth format than the first portion, such as discussed above at least in the context of FIGS. 3A-3C. The second portion of the at least one image is outside of the portion that corresponds to the region of interest.

In some embodiments, the second portion corresponds to at least one environmental image, such as discussed above at least in the context of FIGS. 3B and 3C.

In further embodiments, determining the first portion of the at least one image that corresponds to the region of interest can include determining the first portion of the at least one image in real time, and formatting the at least one image can include formatting the at least one image in real time.

At block 950, the wearable computing device transmits the formatted at least one image. Transmitting images of the real-world environment using different resolutions is discussed above in the context of at least in the context of FIGS. 3B and 3C.

In further embodiments, the wearable computing device can display, on the HMD, an indication of the region of interest. Displaying indications of regions of interest are discussed above in the context of at least in the context of FIGS. 4A-5 and 7A-8B. In some embodiments, displaying, on the HMD, an indication of the region of interest includes displaying an image that indicates the object, such as discussed above in the context of at least in the context of FIGS. 4A-5 and 7A-8B.

In other embodiments of method 900, the wearable computing device can transmit the at least one image of the real-world environment. In some of these other embodiments, the transmitted at least one image can include transmitted video.

In still other embodiments, the region of interest is defined by a focus window such as the rectangular and other-shaped indicators of a region of interest shown in FIGS. 3B-5 and 8B. In some of these other embodiments, displaying an indication of the region of interest on the HMD includes displaying a representation of the focus window overlaying the view of the real-world environment, such as shown in FIGS. 3B-5 and 8B.

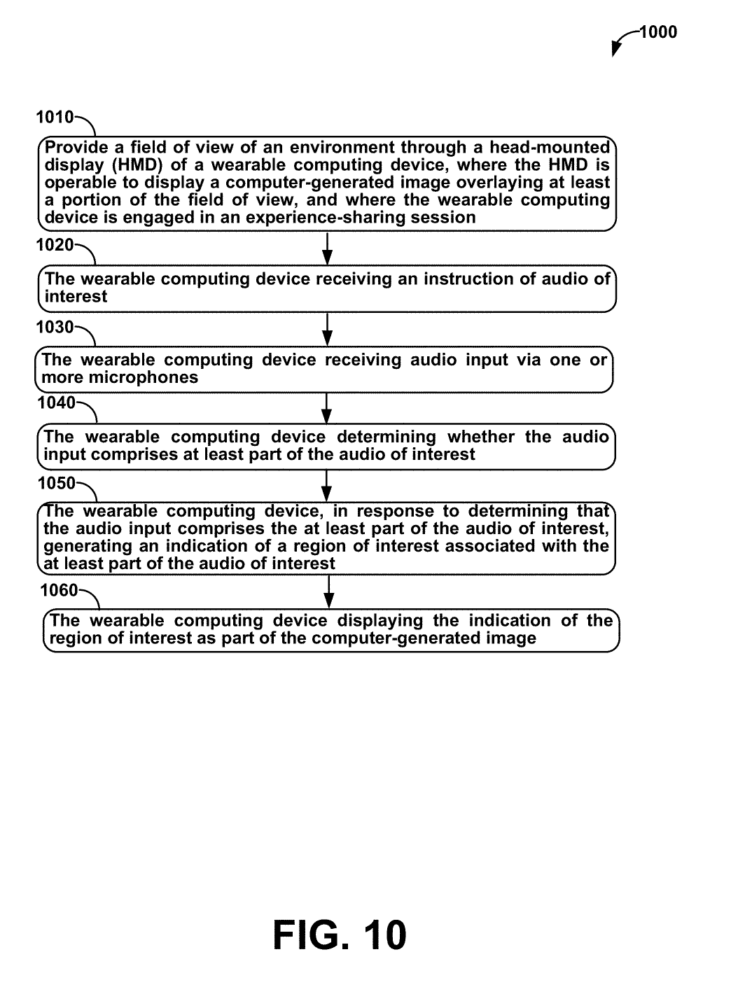

FIG. 10 is a flowchart of a method 1000, in accordance with an example embodiment. At block 1010, a view of a real-world environment is provided through a HMD of a wearable computing device. The HMD is operable to display a computer-generated image overlaying at least a portion of the view. The wearable computing device can be engaged in an experience-sharing session. Views of environments displayed by wearable computing devices are discussed above at least in the context of FIGS. 3A-5, 8A, and 8B.

At block 1020, at least one image of the real-world environment is captured using a camera associated the wearable computing device. Capturing images of the environment are discussed above at least in the context of FIGS. 3A-5, 8A, and 8B.

At block 1020, the wearable computing device receives an indication of audio of interest. Receiving indications of the audio of interest are discussed above in the context of at least in the context of FIGS. 8A and 8B.

At block 1030, the wearable computing device receives audio input via one or more microphones, such as discussed above in the context of at least in the context of FIGS. 8A and 8B.

At block 1040, the wearable computing device can determine whether the audio input includes at least part of the audio of interest. Determining whether or not audio input includes at least part of audio of interest is discussed above in the context of at least in the context of FIGS. 8A and 8B.

At block 1050, the wearable computing device can, in response to determining that the audio input includes at least part of the audio of interest, generate an indication of a region of interest associated with the at least part of the audio of interest. Generating indications of regions of interest associated with audio of interest is discussed above in the context of at least in the context of FIGS. 8A and 8B.

In some embodiments, generating the indication of a region of interest associated with the audio of interest can include: (a) converting the audio input that includes at least part of the audio of interest to text; and (b) generating the indication of the region of interest associated with the at least part of the audio of interest, where the indication includes at least part of the text. Generating indications with text generated from audio is discussed above in the context of at least in the context of FIGS. 8A and 8B.

At block 1060, the wearable computing device can display an indication of the region of interest as part of the computer-generated image. Displaying indications of regions of interest are discussed above in the context of at least in the context of FIGS. 3A-5, 8A, and 8B.

In some embodiments, the wearable computing device can transmit a first portion of the received audio input in a first audio format and a second portion of the received audio input in a second audio format, where the first portion of the video corresponds to the at least part of the audio of interest, and where the first audio format differs from the second audio format. Transmitting audio input using different audio formats is discussed above in the context of at least in the context of FIGS. 8A and 8B.

In other embodiments, each of the one or more microphones is associated with an area. In these other embodiments, receiving audio input via the one or more microphones can include receiving the audio input including the at least part of the audio of interest at a first microphone of the one or more microphones, where the first microphone is related to a first area, and where the region of interest is associated with the first area. Receiving audio input via microphones associated with areas is discussed above in the context of at least in the context of FIGS. 8A and 8B.

In still other embodiments, the wearable computing device can receiving additional audio input via the one or more microphones. The wearable computing device can determine whether the additional audio input includes at least part of the audio of interest. In response to determining that the additional audio input includes the at least part of the audio of interest, the wearable computing device can generate an additional indication of an additional region of interest associated with the at least part of the audio of interest, where the additional indication of the additional region of interest differs from the indication of the region of interest. Generating multiple indications of regions of interest is discussed above at least in the context of FIG. 8B.

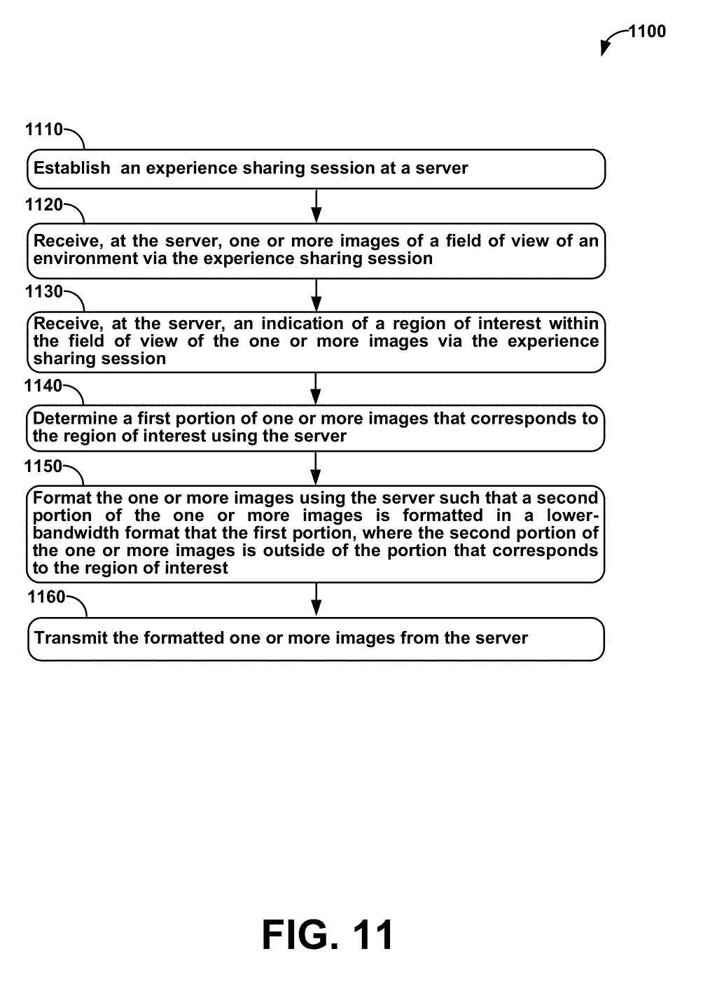

FIG. 11 is a flowchart of a method 1100, in accordance with an example embodiment. At block 1110, a server can establish an experience sharing session, such as discussed above at least in the context of FIGS. 3A-5.

At block 1120, the server can receive one or more images of a field of view of an environment via the experience sharing session, such as discussed above in the context of FIGS. 3A-5, 8A, and 8B.

At block 1130, the server can receive an indication of a region of interest within the field of view of the one or more images via the experience sharing session. Indications of regions of interest are discussed above in the context of at least in the context of FIGS. 4A-5 and 7A-8B.

In some embodiments, the indication of the region of interest within the field of view of the environment can include one or more eye gaze vectors. In these embodiments, method 1100 can further include the server determining the region of interest within the field of view based on the one or more images of the field of view and the one or more eye gaze vectors.

In other embodiments, the server can receive the indication of the region of interest from a sharer of the experience sharing session.

In particular of these embodiments, the server can receive a plurality of indications of regions of interest from a plurality of sharers. In these embodiments, the server can format a plurality of formatted images, wherein a formatted image for a given sharer can include a first portion and a second portion, the first portion formatted in a high-bandwidth format, and the second portion formatted in a low-bandwidth format, wherein the first portion corresponds to the region of interest indicated by the given sharer. Then, the server can send the formatted image for the given sharer to the given sharer.

At block 1140, the server can determine a first portion of the one or more images that corresponds to the region of interest.

At block 1150, the server can format the one or more images such that a second portion of the one or more images is formatted in a lower-bandwidth format that the first portion. The second portion of the one or more images is outside of the portion that corresponds to the region of interest. Formatting portions of the images using different resolutions or formats is discussed above in the context of at least in the context of FIGS. 3B and 3C.

Then, at block 1160, the server can transmit the formatted one or more images. In some embodiments, transmitting the one or more images can include transmitting video data as part of the experience-sharing session. The video data can include the formatted one or more images.

### CONCLUSION

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed systems and methods can be arranged and combined in a wide variety of different configurations, all of which are contemplated herein.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

It should be understood that for situations in which the embodiments discussed herein collect and/or use any personal information about users or information that might relate to personal information of users, the users may be provided with an opportunity to opt in/out of programs or features that involve such personal information (e.g., information about a user's preferences or a user's contributions to social content providers). In addition, certain data may be anonymized in one or more ways before it is stored or used, so that personally identifiable information is removed. For example, a user's identity may be anonymized so that no personally identifiable information can be determined for the user and so that any identified user preferences or user interactions are generalized (for example, generalized based on user demographics) rather than associated with a particular user.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A computer-implemented method, comprising:
providing a field of view of an environment through a display of a computing device, wherein the computing device is operable to overlay a computer-generated image on at least a portion of the field of view, while engaged in an experience-sharing session;
capturing at least one image of the environment using a camera associated with the computing device;
determining, by the computing device, an eye gaze vector associated with the computing device;
determining, by the computing device, based at least in part on the eye gaze vector, a region of interest within the field of view of the environment captured in the at least one image;
generating, using the at least one image, at least one mixed-resolution image in which a first portion corresponding to the determined region of interest has a higher resolution than a background portion;
transmitting, by the computing device, the at least one mixed-resolution image as part of the experience-sharing session.

2. The method of claim 1, wherein transmitting the at least one mixed-resolution image as part of the experience-sharing session comprises transmitting video data that comprises the at least one mixed-resolution image.

3. The method of claim 2, further comprising determining the first portion of the at least one image that corresponds to the region of interest in real time, and
wherein generating the at least one mixed-resolution image comprises generating the at least one mixed-resolution image in real time.

4. The method of claim 3, wherein transmitting the video data that comprises the at least one mixed-resolution image comprises transmitting the video data that comprises the at least one mixed-resolution image in real-time.

5. The method of claim 1, wherein determining the region of interest comprises:
determining a head tilt vector;
determining a gaze direction based on the eye gaze vector and the head tilt vector; and
determining the region of interest based on the gaze direction.

6. The method of claim 1, wherein the computing device comprises a wearable computing device having a photodetector, and wherein determining the region of interest comprises:
determining a position of an iris of an eye of the wearer using the photodetector; and
determining the eye gaze vector based on the position of the iris of the eye.

7. The method of claim 1, wherein the background portion corresponds to at least one environmental image.

8. The method of claim 1, further comprising:
the computing device transmitting the captured at least one image of the environment.

9. The method of claim 1, wherein the experience sharing session comprises an experience sharing session between the computing device and at least one other computing device.

10. The method of claim 1, wherein the region of interest comprises a real-world object in the environment.

11. The method of claim 10, wherein the real-world object in the environment comprises a human face.

12. The method of claim 1, further comprising displaying an indication of the region of interest on the display;
wherein displaying, on the HMD, the indication of the region of interest comprises displaying an image that indicates a real-world object within the region of interest.

13. The method of claim 1, further comprising displaying an indication of the region of interest on the display;
wherein displaying, on the HMD, the indication of the region of interest comprises displaying text that indicates a real-world object within the region of interest.

14. The method of claim 1, wherein the at least one image comprises at least a first image of the field of view of the environment and a second image of the field of view of the environment, wherein the first image is captured before the second image, and wherein the at least one mixed-resolution image is generated from the first image and the second image.

15. The method of claim 14, wherein the at least one mixed-resolution image is based on a difference image generated using the first image and the second image.

16. A method, comprising:
establishing an experience sharing session at a server with a computing device;
receiving, at the server, one or more images of a field of view of an environment captured via a camera associated with the computing device;
receiving, at the server, an indication of an eye gaze vector associated with the computing device;
determining, based at least in part on the eye gaze vector, a region of interest within the field of view of the one or more images;
generating, using the one or more images, at least one mixed-resolution image in which a first portion corresponding to the determined region of interest has a higher resolution than a background portion; and
transmitting the at least one mixed-resolution image.

17. The method of claim 16, wherein transmitting the at least one mixed-resolution image comprises transmitting video data as part of the experience-sharing session, the video data comprising the at least one mixed-resolution image.

18. The method of claim 16, wherein the one or more images comprise at least a first image of the field of view of the environment and a second image of the field of view of the environment, wherein the first image is received before the second image, and wherein the at least one mixed-resolution image is generated from the first image and the second image.

19. The method of claim 18, wherein the at least one mixed-resolution image is based on a difference image generated using the first image and the second image.

20. A computing device, comprising:
a processor; and
memory having one or more instructions that, in response to execution by the processor, cause the computing device to:
establish an experience sharing session with at least one computing device,
receive one or more images of a field of view of an environment captured via a camera associated with the computing device,
receive an indication of an eye gaze vector for a wearer of the computing device,
determine, based at least in part on the eye gaze vector, a region of interest within the field of view of the one or more images,
generate, using the one or more images, at least one mixed-resolution image in which a first portion corresponding to the determined region of interest has a higher resolution than a background portion, and
transmit the at least one mixed-resolution image.
